(19) United States
(12) Patent Application Publication
(10) Pub. No.: US 2025/0239612 A1
(43) Pub. Date: Jul. 24, 2025

(54) NEGATIVE ELECTRODE WATERBORNE SLURRY COMPOSITIONS FOR LITHIUM ION ELECTRICAL STORAGE DEVICES

(71) Applicant: PPG Industries Ohio, Inc., Cleveland, OH (US)

(72) Inventors: Adam Jacob Crowe, Chesterfield, MI (US); Haley Lynn Gray, Bridgeville, PA (US); Scott William Sisco, Glenshaw, PA (US); John Leonard DiMeglio, Pittsburgh, PA (US); Kevin Thomas Slyvester, Pittsburgh, PA (US)

(73) Assignee: PPG Industries Ohio, Inc., Cleveland, OH (US)

(21) Appl. No.: 18/698,406

(22) PCT Filed: Aug. 5, 2022
(86) PCT No.: PCT/US2022/074576

§ 371 Date: Apr. 4, 2024

Related U.S. Application Data
(60) Provisional application No. 63/252,634, filed on Oct. 6, 2021.

(51) Int. Cl. H01M 4/62; H01M 4/02

(52) U.S. Cl. CPC H01M 4/622; H01M 4/625; H01M 2004/027

(57) ABSTRACT

The present disclosure provides a negative electrode waterborne slurry composition comprising a binder; optionally a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant; a negative electrode active material; optionally a poly(2-alkyl or aryl oxazoline) polymer, wherein at least one of the dispersant and the poly(2-alkyl or aryl oxazoline) polymer are present; and an aqueous medium. Also disclosed are negative electrodes and electrical storage devices.

### NOTICE OF GOVERNMENT SUPPORT

This invention was made with Government support under Government Contract No. 201950-140969 awarded by the Department of Defense. The United States Government has certain rights in this invention.

### FIELD

The disclosure relates to slurry compositions that could be used in manufacturing negative electrodes for use in electrical storage devices, such as batteries.

### BACKGROUND

There is a trend in the electronics industry to produce smaller devices, powered by smaller and lighter batteries. As battery uses further move toward fast (dis)charge applications, the battery electrode coatings will be required to withstand harsher operating conditions. Negative electrodes typically employ a carbonaceous material as a negative electrode active material with an optional electrically conductive additive (which may also be carbonaceous); however, these materials can be difficult to uniformly disperse in waterborne electrode slurries, the current methods of improving dispersion are expensive and are typically added in higher levels to facilitate rapid (dis)charge applications. If conductive additives are sufficiently dispersed throughout the electrode coating while maintaining physical/electrical contact, fast charge and/or discharge applications can be realized. As a result, an improved waterborne negative electrode slurry composition is desired.

### BRIEF DESCRIPTION OF THE DRAWINGS

FIG. 1 is a series of black-and-white photographs of coatings of carbon dispersions that were applied onto a substrate via drawdown method and show the quality of the applied coating.

FIG. 2 is black-and-white TEM images of carbon-containing films.

FIG. 3 is a graph showing cell data as a function of time.

### SUMMARY

The present disclosure provides a negative electrode waterborne slurry composition comprising a binder; a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an alpha, beta-ethylenically unsaturated carboxylic acid-functional monomer, wherein the dispersant comprises 1% to 50% by weight of constitutional units comprising the residue of a monomer comprising a nitrogen-containing heterocycle and the % by weight is based on the total weight of the dispersant; a negative electrode active material; and an aqueous medium.

The present disclosure also provides a negative electrode waterborne slurry composition comprising a binder; a poly(2-alkyl or aryl oxazoline) polymer; a negative electrode active material; and an aqueous medium.

The present disclosure further provides a negative electrode comprising: (a) an electrical current collector; and (b) a film formed on the electrical current collector, wherein the film comprises: a binder; optionally a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant; optionally the poly(2-alkyl or aryl oxazoline) polymer, wherein at least one of the dispersant and the poly(2-alkyl or aryl oxazoline) polymer are present; and a negative electrode active material.

The present disclosure further provides a negative electrode comprising: (a) an electrical current collector; and (b) a film formed on the electrical current collector, wherein the film comprises: a binder; a negative electrode active material; and at least one of: a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant; or a poly(2-alkyl or aryl oxazoline) polymer.

The present disclosure also provides an electrical storage device comprising: (a) a negative electrode of the present disclosure; (b) a positive electrode; and (c) an electrolyte.

The present disclosure further provides a negative electrode waterborne slurry composition comprising: a negative electrode active material; a binder comprising a cellulose or a cellulose derivative and a styrene-butadiene copolymer; a melamine crosslinking agent; and an aqueous medium.

### DETAILED DESCRIPTION

The present disclosure is directed to a negative electrode waterborne slurry composition comprising a binder; a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant; a negative electrode active material; and an aqueous medium.

The binder may comprise any suitable binder resin for a negative electrode

waterborne slurry composition. For example, the binder may comprise fluoropolymers such as polyvinylidene fluoride (PVDF), polytetrafluoroethylene, tetrafluoroethylene-hexafluoropropylene copolymers, vinylidene fluoride-hexafluoropropylene copolymers and vinylidene fluoride-chlorotrifluoroethylene copolymers; polyolefin resins such as ethylene-propylene-diene ternary copolymers, polyethylene, polypropylene, ethylene-vinyl acetate copolymers and ethylene-ethyl acrylate copolymers; polystyrene resins such as polystyrene, acrylonitrile styrene copolymers, acrylonitrile-butadiene-styrene copolymers, methyl methacrylate-styrene copolymers and styrene-butadiene rubbers; polycarbonate resins, vinyl chloride resins, polyamide resins, polyimide resins, (meth)acrylic resins such as polyacrylic acid, ammonium polyacrylate, sodium polyacrylate and polymethyl methacrylate, polyester resins such as polyethylene terephthalate, polybutylene terephthalate, polyethylene naphthalate, polybutylene naphthalate, polylactic acid, poly-3-hydroxybutyric acid, polycaprolactone, polybutylene succinate and polyethylene succinate/adipate; polyphenylene ether resins, modified polyphenylene ether resins, polyacetal resins, polysulfone resins, polyphenylene sulfide resins, polyvinyl alcohol resins; chitin, chitosan and lignin; epoxy resins, urethane acrylate, phenolic resins, melamine resins, urea resins and alkyd resins, as well as any combination thereof.

As noted above, the binder may optionally comprise a styrene butadiene copolymer. As used herein, the term “styrene butadiene copolymer” refers to copolymers that comprise styrene (or a derivative thereof) and butadiene.

The styrene butadiene copolymer may be present in the binder in amounts of at least at least 20% by weight, such as at least 30% by weight, such as at least 40% by weight, such as at least 45% by weight, such as at least 50% by weight, such as at least 65% by weight, such as at least 80% by weight, such as at least 90% by weight, such as at least 95% by weight, based on the total weight of the binder solids. The styrene butadiene copolymer may be present in the binder in amounts of 99.9% by weight, such as no more than 95% by weight, such as no more than 85% by weight, such as no more than 75% by weight, such as no more than 65% by weight, such as no more than 55% by weight, such as no more than 50% by weight, such as no more than 45% by weight, based on the total weight of the binder solids. The styrene butadiene copolymer may be present in the binder in amounts of 20% to 99.9% by weight, such as 20% to 95% by weight, such as 20% to 85% by weight, such as 20% to 75% by weight, such as 20% to 65% by weight, such as 20% to 55% by weight, such as 20% to 50% by weight, such as 20% to 45% by weight, such as 30% to 99.9% by weight, such as 30% to 95% by weight, such as 30% to 85% by weight, such as 30% to 75% by weight, such as 30% to 65% by weight, such as 30% to 55% by weight, such as 30% to 50% by weight, such as 30% to 45% by weight, such as 40% to 99.9% by weight, such as 40% to 95% by weight, such as 40% to 85% by weight, such as 40% to 75% by weight, such as 40% to 65% by weight, such as 40% to 55% by weight, such as 40% to 50% by weight, such as 40% to 45% by weight, such as 50% to 99.9% by weight, such as 50% to 95% by weight, such as 50% to 85% by weight, such as 50% to 75% by weight, such as 50% to 65% by weight, such as 50% to 55% by weight, such as 65% to 99.9% by weight, such as 65% to 95% by weight, such as 65% to 85% by weight, such as 65% to 75% by weight, 80% to 99.9% by weight, such as 80% to 95% by weight, such as 80% to 85% by weight, 90% to 99.9% by weight, such as 90% to 95% by weight, 95% to 99.9% by weight, based on the total weight of the binder solids.

The styrene butadiene copolymer may be present in the slurry composition in an amount of at least 0.1% by weight, such as at least 0.5% by weight, such as at least 1% by weight, such as at least 2% by weight, such as at least 3% by weight, such as at least 4% by weight, based on the total solids weight of the slurry composition. The styrene butadiene copolymer may be present in an amount of no more than 10% by weight, such as no more than 8% by weight, such as no more than 5% by weight, such as no more than 4% by weight, such as no more than 3% by weight, such as no more than 2% by weight, such as no more than 1% by weight, based on the total solids weight of the slurry composition. The styrene butadiene copolymer may be present in an amount of 0.1% to 10% by weight, such as 0.1% to 8% by weight, such as 0.1% to 5% by weight, such as 0.1% to 4% by weight, such as 0.1% to 3% by weight, such as 0.1% to 2% by weight, such as 0.1% to 1% by weight, such as 0.5% to 10% by weight, such as 0.5% to 8% by weight, such as 0.5% to 5% by weight, such as 0.5% to 4% by weight, such as 0.5% to 3% by weight, such as 0.5% to 2% by weight, such as 0.5% to 1% by weight, such as 1% to 10% by weight, such as 1% to 8% by weight, such as 1% to 5% by weight, such as 1% to 4% by weight, such as 1% to 3% by weight, such as 1% to 2% by weight, such as 2% to 10% by weight, such as 2% to 8% by weight, such as 2% to 5% by weight, such as 2% to 4% by weight, such as 2% to 3% by weight, such as 3% to 10% by weight, such as 3% to 8% by weight, such as 3% to 5% by weight, such as 3% to 4% by weight, 4% to 5% by weight, based on the total solids weight of the slurry composition.

The styrene butadiene copolymer may be present in the slurry composition in an amount of at least 0.05% by weight, such as at least 0.25% by weight, such as at least 0.5% by weight, such as at least 1% by weight, such as at least 1.5% by weight, such as at least 2% by weight, based on the total weight of the slurry composition. The styrene butadiene copolymer may be present in an amount of no more than 4% by weight, such as no more than 3.5% by wight, such as no more than 3% by weight, such as no more than 2.5% by weight, such as no more than 2% by weight, such as no more than 1.5% by weight, such as no more than 1% by weight, such as no more than 0.5% by weight, based on the total weight of the slurry composition. The styrene butadiene copolymer may be present in an amount of 0.05% to 4% by weight, such as 0.05% to 3.5% by weight, such as 0.05% to 3% by weight, such as 0.05% to 2.5% by weight, such as 0.05% to 2% by weight, such as 0.05% to 1.5% by weight, such as 0.05% to 1% by weight, such as 0.05% to 0.5% by weight, such as 0.25% to 4% by weight, such as 0.25% to 3.5% by weight, such as 0.25% to 3% by weight, such as 0.25% to 2.5% by weight, such as 0.25% to 2% by weight, such as 0.25% to 1.5% by weight, such as 0.25% to 1% by weight, such as 0.25% to 0.5% by weight, such as 0.5% to 4% by weight, such as 0.5% to 3.5% by weight, such as 0.5% to 3% by weight, such as 0.5% to 2.5% by weight, such as 0.5% to 2% by weight, such as 0.5% to 1.5% by weight, such as 0.5% to 1% by weight, such as 1% to 4% by weight, such as 1% to 3.5% by weight, such as 1% to 3% by weight, such as 1% to 2.5% by weight, such as 1% to 2% by weight, such as 1% to 1.5% by weight, such as 1.5% to 4% by weight, such as 1.5% to 3.5% by weight, such as 1.5% to 3% by weight, such as 1.5% to 2.5% by weight, such as 1.5% to 2% by weight, such as 2% to 4% by weight, such as 2% to 3.5% by weight, such as 2% to 3% by weight, such as 2% to 2.5% by weight, based on the total weight of the slurry composition.

The slurry composition and binder may optionally further comprise a cellulose derivative. The cellulose derivative may be, for example, carboxymethylcellulose and salts thereof (CMC). CMC is a cellulosic ether in which a portion of the hydroxyl groups on the anhydroglucose rings are substituted with carboxymethyl groups. The degree of carboxymethyl substitution can range from 0.4-3. Since CMC is a long chain polymer, its viscosity in aqueous solutions depends on its molecular weight that can vary between 50,000 and 2,000,000 g/mol on a weight average basis. The carboxymethylcellulose may have a weight average molecular weight of at least 50,000 g/mol, such as at least 100,000 g/mol, or some cases, at least 200,000 g/mol, such as at least 250,000 g/mol. The carboxymethylcellulose may have a weight average molecular weight of no more than 2,000,000 g/mol, such as no more than 1,000,000 g/mol, such as no more than 500,000 g/mol, such as no more than 350,000 g/mol, such as no more than 300,000 g/mol. The carboxymethylcellulose may have a weight average molecular weight of 50,000 to 2,000,000 g/mol, such as 50,000 to 1,000,000 g/mol, such as 50,000 to 500,000 g/mol, such as 50,000 to 350,000 g/mol, such as 50,000 to 300,000 g/mol, such as 100,000 to 2,000,000 g/mol, such as 100,000 to 1,000,000 g/mol, such as 100,000 to 500,000 g/mol, such as 100,000 to 350,000 g/mol, such as 100,000 to 300,000 g/mol, such as 250,000 to 2,000,000 g/mol, such as 250,000 to 1,000,000 g/mol, such as 250,000 to 500,000 g/mol, such as 250,000 to 350,000 g/mol, such as 250,000 to 300,000 g/mol. The degree of CMC substitution (DS) may be at least at least 0.4, such as at least 0.5, such as at least 0.6, such as at least 0.7, such as at least 0.8, such as at least 0.9, such as at least 1, such as at least 1.1, such as at least 1.2. The degree of CMC substitution (DS) may be no more than 3, such as no more than 2, such as no more than 1.4, such as no more than 1.2, such as no more than 1, such as no more than 0.8, such as no more than 0.7. The degree of CMC substitution (DS) may be 0.4 to 3, such as 0.4 to 2, such as 0.4 to 1.4, such as 0.4 to 1.2, such as 0.4 to 1, such as 0.4 to 0.8, such as 0.4 to 0.7, such as 0.5 to 3, such as 0.5 to 2, such as 0.5 to 1.4, such as 0.5 to 1.2, such as 0.5 to 1, such as 0.5 to 0.8, such as 0.5 to 0.7, such as 0.6 to 3, such as 0.6 to 2, such as 0.6 to 1.4, such as 0.6 to 1.2, such as 0.6 to 1, such as 0.6 to 0.8, such as 0.6 to 0.7, such as 0.7 to 3, such as 0.7 to 2, such as 0.7 to 1.4, such as 0.7 to 1.2, such as 0.7 to 1, such as 0.7 to 0.8, such as 0.8 to 3, such as 0.8 to 2, such as 0.8 to 1.4, such as 0.8 to 1.2, such as 0.8 to 1, such as 0.9 to 3, such as 0.9 to 2, such as 0.9 to 1.4, such as 0.9 to 1.2, such as 0.9 to 1, such as 1 to 3, such as 1 to 2, such as 1 to 1.4, such as 1 to 1.2, such as 1.1 to 3, such as 1.1 to 2, such as 1.1 to 1.4, such as 1.1 to 1.2, such as 1.2 to 3, such as 1.2 to 2, such as 1.2 to 1.4.

The cellulose derivative may be present in the binder in amounts of at least 20% by weight, such as at least 30% by weight, such as at least 40% by weight, such as at least 45% by weight, such as at least 50% by weight, such as at least 65% by weight, such as at least 80% by weight, such as at least 90% by weight, such as at least 95% by weight, based on the total weight of the binder solids. The cellulose derivative may be present in the binder in amounts of 99.9% by weight, such as no more than 95% by weight, such as no more than 85% by weight, such as no more than 75% by weight, such as no more than 65% by weight, such as no more than 55% by weight, such as no more than 50% by weight, such as no more than 45% by weight, based on the total weight of the binder solids. The cellulose derivative may be present in the binder in amounts of 20% to 99.9% by weight, such as 20% to 95% by weight, such as 20% to 85% by weight, such as 20% to 75% by weight, such as 20% to 65% by weight, such as 20% to 55% by weight, such as 20% to 50% by weight, such as 20% to 45% by weight, such as 30% to 99.9% by weight, such as 30% to 95% by weight, such as 30% to 85% by weight, such as 30% to 75% by weight, such as 30% to 65% by weight, such as 30% to 55% by weight, such as 30% to 50% by weight, such as 30% to 45% by weight, such as 40% to 99.9% by weight, such as 40% to 95% by weight, such as 40% to 85% by weight, such as 40% to 75% by weight, such as 40% to 65% by weight, such as 40% to 55% by weight, such as 40% to 50% by weight, such as 40% to 45% by weight, such as 50% to 99.9% by weight, such as 50% to 95% by weight, such as 50% to 85% by weight, such as 50% to 75% by weight, such as 50% to 65% by weight, such as 50% to 55% by weight, such as 65% to 99.9% by weight, such as 65% to 95% by weight, such as 65% to 85% by weight, such as 65% to 75% by weight, 80% to 99.9% by weight, such as 80% to 95% by weight, such as 80% to 85% by weight, 90% to 99.9% by weight, such as 90% to 95% by weight, 95% to 99.9% by weight, based on the total weight of the binder solids.

The cellulose derivative may be present in the slurry composition in an amount of at least 0.1% by weight, such as at least 0.5% by weight, such as at least 1% by weight, such as at least 2% by weight, such as at least 3% by weight, such as at least 4% by weight, based on the total solids weight of the slurry composition. The cellulose derivative may be present in an amount of no more than 10% by weight, such as no more than 8% by weight, such as no more than 5% by weight, such as no more than 4% by weight, such as no more than 3% by weight, such as no more than 2% by weight, such as no more than 1% by weight, based on the total solids weight of the slurry composition. The cellulose derivative may be present in an amount of 0.1% to 10% by weight, such as 0.1% to 8% by weight, such as 0.1% to 5% by weight, such as 0.1% to 4% by weight, such as 0.1% to 3% by weight, such as 0.1% to 2% by weight, such as 0.1% to 1% by weight, such as 0.5% to 10% by weight, such as 0.5% to 8% by weight, such as 0.5% to 5% by weight, such as 0.5% to 4% by weight, such as 0.5% to 3% by weight, such as 0.5% to 2% by weight, such as 0.5% to 1% by weight, such as 1% to 10% by weight, such as 1% to 8% by weight, such as 1% to 5% by weight, such as 1% to 4% by weight, such as 1% to 3% by weight, such as 1% to 2% by weight, such as 2% to 10% by weight, such as 2% to 8% by weight, such as 2% to 5% by weight, such as 2% to 4% by weight, such as 2% to 3% by weight. such as 3% to 10% by weight, such as 3% to 8% by weight, such as 3% to 5% by weight, such as 3% to 4% by weight, 4% to 5% by weight, based on the total solids weight of the slurry composition.

The cellulose derivative may be present in the slurry composition in an amount of at least 0.05% by weight, such as at least 0.25% by weight, such as at least 0.5% by weight, such as at least 1% by weight, such as at least 1.5% by weight, such as at least 2% by weight, based on the total weight of the slurry composition. The cellulose derivative may be present in an amount of no more than 4% by weight, such as no more than 3.5% by weight, such as no more than 3% by weight, such as no more than 2.5% by weight, such as no more than 2% by weight, such as no more than 1.5% by weight, such as no more than 1% by weight, such as no more than 0.5% by weight, based on the total weight of the slurry composition. The cellulose derivative may be present in an amount of 0.05% to 4% by weight, such as 0.05% to 3.5% by weight, such as 0.05% to 3% by weight, such as 0.05% to 2.5% by weight, such as 0.05% to 2% by weight, such as 0.05% to 1.5% by weight, such as 0.05% to 1% by weight, such as 0.05% to 0.5% by weight, such as 0.25% to 4% by weight, such as 0.25% to 3.5% by weight, such as 0.25% to 3% by weight, such as 0.25% to 2.5% by weight, such as 0.25% to 2% by weight, such as 0.25% to 1.5% by weight, such as 0.25% to 1% by weight, such as 0.25% to 0.5% by weight, such as 0.5% to 4% by weight, such as 0.5% to 3.5% by weight, such as 0.5% to 3% by weight, such as 0.5% to 2.5% by weight, such as 0.5% to 2% by weight, such as 0.5% to 1.5% by weight, such as 0.5% to 1% by weight, such as 1% to 4% by weight, such as 1% to 3.5% by weight, such as 1% to 3% by weight, such as 1% to 2.5% by weight, such as 1% to 2% by weight, such as 1% to 1.5% by weight, such as 1.5% to 4% by weight, such as 1.5% to 3.5% by weight, such as 1.5% to 3% by weight, such as 1.5% to 2.5% by weight, such as 1.5% to 2% by weight, such as 2% to 4% by weight, such as 2% to 3.5% by weight, such as 2% to 3% by weight, such as 2% to 2.5% by weight, based on the total weight of the slurry composition.

According to the present disclosure, the slurry composition further comprises a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant.

The dispersant copolymer comprises at least 1% by weight of constitutional units comprising the residue of a monomer comprising a nitrogen-containing heterocycle, such as at least 3% by weight, such as at least 5% by weight, such as at least 7% by weight, such as at least 9% by weight, such as at least 12% by weight, such as at least 15% by weight, based on the total weight of the dispersant. Non-limiting examples of ethylenically unsaturated monomers comprising a nitrogen-containing heterocycle includes N-vinyl pyrrolidone, N-vinylcaprolactam, N-vinylimidazole, vinyl methyl oxazolidinone, among others. The dispersant copolymer comprises no more than 50% by weight of constitutional units comprising the residue of a monomer comprising a nitrogen-containing heterocycle, such as no more than 30% by weight, such as no more than 20% by weight, such as no more than 15% by weight, such as no more than 12% by weight, such as no more than 10% by weight, such as no more than 7% by weight, such as no more than 5% by weight, based on the total weight of the dispersant. The dispersant copolymer comprises 1% to 50% by weight of constitutional units comprising the residue of a monomer comprising a nitrogen-containing heterocycle, such as 1% to 30% by weight, such as 1% to 20% by weight, such as 1% to 15% by weight, such as 1% to 12% by weight, such as 1% to 10% by weight, such as 1% to 7% by weight, such as 1% to 5% by weight, such as 3% to 50% by weight, such as 3% to 30% by weight, such as 3% to 20% by weight, such as 3% to 15% by weight, such as 3% to 12% by weight, such as 3% to 10% by weight, such as 3% to 7% by weight, such as 3% to 5% by weight, such as 5% to 50% by weight, such as 5% to 30% by weight, such as 5% to 20% by weight, such as 5% to 15% by weight, such as 5% to 12% by weight, such as 5% to 10% by weight, such as 5% to 7% by weight, such as 7% to 50% by weight, such as 7% to 30% by weight, such as 7% to 20% by weight, such as 7% to 15% by weight, such as 7% to 12% by weight, such as 7% to 10% by weight, such as 9% to 50% by weight, such as 9% to 30% by weight, such as 9% to 20% by weight, such as 9% to 15% by weight, such as 9% to 12% by weight, such as 9% to 10% by weight, such as 12% to 50% by weight, such as 12% to 30% by weight, such as 12% to 20% by weight, such as 12% to 15% by weight, such as 15% to 50% by weight, such as 15% to 30% by weight, such as 15% to 20% by weight, based on the total weight of the dispersant. The dispersant copolymer may be derived from a reaction mixture comprising the ethylenically unsaturated monomer comprising a nitrogen-containing heterocycle in an amount of 1% to 50% by weight of the ethylenically unsaturated monomer comprising a nitrogen-containing heterocycle, such as 1% to 30% by weight, such as 1% to 20% by weight, such as 1% to 15% by weight, such as 1% to 12% by weight, such as 1% to 10% by weight, such as 1% to 7% by weight, such as 1% to 5% by weight, such as 3% to 50% by weight, such as 3% to 30% by weight, such as 3% to 20% by weight, such as 3% to 15% by weight, such as 3% to 12% by weight, such as 3% to 10% by weight, such as 3% to 7% by weight, such as 3% to 5% by weight, such as 5% to 50% by weight, such as 5% to 30% by weight, such as 5% to 20% by weight, such as 5% to 15% by weight, such as 5% to 12% by weight, such as 5% to 10% by weight, such as 5% to 7% by weight, such as 7% to 50% by weight, such as 7% to 30% by weight, such as 7% to 20% by weight, such as 7% to 15% by weight, such as 7% to 12% by weight, such as 7% to 10% by weight, such as 9% to 50% by weight, such as 9% to 30% by weight, such as 9% to 20% by weight, such as 9% to 15% by weight, such as 9% to 12% by weight, such as 9% to 10% by weight, such as 12% to 50% by weight, such as 12% to 30% by weight, such as 12% to 20% by weight, such as 12% to 15% by weight, such as 15% to 50% by weight, such as 15% to 30% by weight, such as 15% to 20% by weight, based on the total weight of polymerizable monomers used in the reaction mixture.

The dispersant copolymer further comprises constitutional units comprising the residue of an alkyl ester of a (meth)acrylic acid and/or the residue of an alpha, beta-ethylenically unsaturated carboxylic acid-functional monomer. The constitutional units comprising the residue of an alkyl ester of a (meth)acrylic acid and/or the residue of an alpha, beta-ethylenically unsaturated carboxylic acid-functional monomer may comprise at least at least 1% by weight, such as at least 15% by weight, such as at least 30% by weight, such as at least 35% by weight, such as at least 40% by weight, such as at least 45% by weight, such as at least 50% by weight, such as at least 55% by weight, such as at least 60% by weight, such as at least 70% by weight, such as at least 75% by weight, such as at least 80% by weight, based on the total weight of the dispersant copolymer. The constitutional units comprising the residue of an alkyl ester of a (meth)acrylic acid and/or the residue of an alpha, beta-ethylenically unsaturated carboxylic acid-functional monomer may comprise no more than 99% by weight, such as no more than 90% by weight, such as no more than 85% by weight, such as no more than 80% by weight, such as no more than 75% by weight, such as no more than 70% by weight, such as no more than 65% by weight, such as no more than 60% by weight, such as no more than 50% by weight, based on the total weight of the dispersant copolymer. The constitutional units comprising the residue of an alkyl ester of a (meth)acrylic acid and/or the residue of an alpha, beta-ethylenically unsaturated carboxylic acid-functional monomer may comprise such as 1% to 99% by weight, such as 1% to 90% by weight, such as 1% to 85% by weight, such as 1% to 80% by weight, such as 1% to 75% by weight, such as 1% to 70% by weight, such as 1% to 65% by weight, such as 1% to 60% by weight, such as 1% to 50% by weight, such as 15% to 99% by weight, such as 15% to 90% by weight, such as 15% to 85% by weight, such as 15% to 80% by weight, such as 15% to 75% by weight, such as 15% to 70% by weight, such as 15% to 65% by weight, such as 15% to 60% by weight, such as 15% to 50% by weight, such as 30% to 99% by weight, such as 30% to 90% by weight, such as 30% to 85% by weight, such as 30% to 80% by weight, such as 30% to 75% by weight, such as 30% to 70% by weight, such as 30% to 65% by weight, such as 30% to 60% by weight, such as 30% to 50% by weight, such as 35% to 99% by weight, such as 35% to 90% by weight, such as 35% to 85% by weight, such as 35% to 80% by weight, such as 35% to 75% by weight, such as 35% to 70% by weight, such as 35% to 65% by weight, such as 35% to 60% by weight, such as 35% to 50% by weight, such as 40% to 99% by weight, such as 40% to 90% by weight, such as 40% to 85% by weight, such as 40% to 80% by weight, such as 40% to 75% by weight, such as 40% to 70% by weight, such as 40% to 65% by weight, such as 40% to 60% by weight, such as 40% to 50% by weight, such as 45% to 99% by weight, such as 45% to 90% by weight, such as 45% to 85% by weight, such as 45% to 80% by weight, such as 45% to 75% by weight, such as 45% to 70% by weight, such as 45% to 65% by weight, such as 45% to 60% by weight, such as 45% to 50% by weight, such as 50% to 99% by weight, such as 50% to 90% by weight, such as 50% to 85% by weight, such as 50% to 80% by weight, such as 50% to 75% by weight, such as 50% to 70% by weight, such as 50% to 65% by weight, such as 50% to 60% by weight, such as 55% to 99% by weight, such as 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 99% by weight, such as 60% to 90% by weight, such as 60% to 85% by weight, such as 60% to 80% by weight, such as 60% to 75% by weight, such as 60% to 70% by weight, such as 60% to 65% by weight, based on the total weight of the dispersant copolymer. The dispersant copolymer may be derived from a reaction mixture comprising the alkyl esters of (meth)acrylic acid and/or the alpha, beta-ethylenically unsaturated carboxylic acid-functional monomer in an amount of 1% to 99% by weight, such as 1% to 90% by weight, such as 1% to 85% by weight, such as 1% to 80% by weight, such as 1% to 75% by weight, such as 1% to 70% by weight, such as 1% to 65% by weight, such as 1% to 60% by weight, such as 1% to 50% by weight, such as 15% to 99% by weight, such as 15% to 90% by weight, such as 15% to 85% by weight, such as 15% to 80% by weight, such as 15% to 75% by weight, such as 15% to 70% by weight, such as 15% to 65% by weight, such as 15% to 60% by weight, such as 15% to 50% by weight, such as 30% to 99% by weight, such as 30% to 90% by weight, such as 30% to 85% by weight, such as 30% to 80% by weight, such as 30% to 75% by weight, such as 30% to 70% by weight, such as 30% to 65% by weight, such as 30% to 60% by weight, such as 30% to 50% by weight, such as 35% to 99% by weight, such as 35% to 90% by weight, such as 35% to 85% by weight, such as 35% to 80% by weight, such as 35% to 75% by weight, such as 35% to 70% by weight, such as 35% to 65% by weight, such as 35% to 60% by weight, such as 35% to 50% by weight, such as 40% to 99% by weight, such as 40% to 90% by weight, such as 40% to 85% by weight, such as 40% to 80% by weight, such as 40% to 75% by weight, such as 40% to 70% by weight, such as 40% to 65% by weight, such as 40% to 60% by weight, such as 40% to 50% by weight, such as 45% to 99% by weight, such as 45% to 90% by weight, such as 45% to 85% by weight, such as 45% to 80% by weight, such as 45% to 75% by weight, such as 45% to 70% by weight, such as 45% to 65% by weight, such as 45% to 60% by weight, such as 45% to 50% by weight, such as 50% to 99% by weight, such as 50% to 90% by weight, such as 50% to 85% by weight, such as 50% to 80% by weight, such as 50% to 75% by weight, such as 50% to 70% by weight, such as 50% to 65% by weight, such as 50% to 60% by weight, such as 55% to 99% by weight, such as 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 99% by weight, such as 60% to 90% by weight, such as 60% to 85% by weight, such as 60% to 80% by weight, such as 60% to 75% by weight, such as 60% to 70% by weight, such as 60% to 65% by weight, based on the total weight of polymerizable monomers used in the reaction mixture.

In addition or in lieu of constitutional units comprising the residue of an alpha, beta-ethylenically unsaturated carboxylic acid, the dispersant copolymer may comprise constitutional units comprising the residue of an alkyl ester of (meth)acrylic acid. The alkyl ester of (meth)acrylic acid may comprise from 1 to 18 carbon atoms in the alkyl group, such as 1 to 12 carbon atoms, such as 1 to 8 carbons, such as 1 to 6 carbon atoms, such as 1 to 4 carbon atoms, such as 1 to 3 carbon atoms, such as 1 to 2 carbon atoms, such as 2 to 18 carbon atoms, such as 2 to 12 carbon atoms, such as 2 to 8 carbons, such as 2 to 6 carbon atoms, such as 2 to 4 carbon atoms, such as 2 to 3 carbon atoms, such as 3 to 18 carbon atoms, such as 3 to 12 carbon atoms, such as 3 to 8 carbons, such as 3 to 6 carbon atoms, such as 3 to 4 carbon atoms, such as 4 to 18 carbon atoms, such as 4 to 12 carbon atoms, such as 4 to 11 carbon atoms, such as 4 to 10 carbon atoms, such as 4 to 9 carbon atoms, such as 4 to 8 carbons, such as 4 to 7 carbon atoms, such as 4 to 6 carbon atoms. Non-limiting examples of alkyl esters of (meth)acrylic acid include methyl (meth)acrylate, ethyl (meth)acrylate, propyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate, and dodecyl (meth)acrylate, as well as alkyl ester of (meth)acrylic acids having cycloaliphatic groups, such as cyclohexyl (meth)acrylate, isobornyl (meth)acrylate, and others. The constitutional units comprising the residue of the alkyl esters of (meth)acrylic acid may comprise at least 30% by weight, such as at least 35% by weight, such as at least 40% by weight, such as at least 45% by weight, such as at least 50% by weight, such as at least 55% by weight, such as at least 60% by weight, such as at least 70% by weight, such as at least 75% by weight, such as at least 80% by weight, based on the total weight of the dispersant copolymer. The constitutional units comprising the residue of the alkyl esters of (meth)acrylic acid may comprise no more than 99% by weight, such as no more than 90% by weight, such as no more than 85% by weight, such as no more than 80% by weight, such as no more than 75% by weight, such as no more than 70% by weight, such as no more than 65% by weight, such as no more than 60% by weight, based on the total weight of the dispersant copolymer. The constitutional units comprising the residue of the alkyl esters of (meth)acrylic acid may comprise such as 30% to 99% by weight, such as 30% to 90% by weight, such as 30% to 85% by weight, such as 30% to 80% by weight, such as 30% to 75% by weight, such as 30% to 70% by weight, such as 30% to 65% by weight, such as 30% to 60% by weight, such as 35% to 99% by weight, such as 35% to 90% by weight, such as 35% to 85% by weight, such as 35% to 80% by weight, such as 35% to 75% by weight, such as 35% to 70% by weight, such as 35% to 65% by weight, such as 35% to 60% by weight, such as 40% to 99% by weight, such as 40% to 90% by weight, such as 40% to 85% by weight, such as 40% to 80% by weight, such as 40% to 75% by weight, such as 40% to 70% by weight, such as 40% to 65% by weight, such as 40% to 60% by weight, such as 45% to 99% by weight, such as 45% to 90% by weight, such as 45% to 85% by weight, such as 45% to 80% by weight, such as 45% to 75% by weight, such as 45% to 70% by weight, such as 45% to 65% by weight, such as 45% to 60% by weight, such as 50% to 99% by weight, such as 50% to 90% by weight, such as 50% to 85% by weight, such as 50% to 80% by weight, such as 50% to 75% by weight, such as 50% to 70% by weight, such as 50% to 65% by weight, such as 50% to 60% by weight, such as 55% to 99% by weight, such as 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 99% by weight, such as 60% to 90% by weight, such as 60% to 85% by weight, such as 60% to 80% by weight, such as 60% to 75% by weight, such as 60% to 70% by weight, such as 60% to 65% by weight, based on the total weight of the dispersant copolymer. The dispersant copolymer may be derived from a reaction mixture comprising the alkyl esters of (meth)acrylic acid in an amount of 30% to 99% by weight, such as 30% to 90% by weight, such as 30% to 85% by weight, such as 30% to 80% by weight, such as 30% to 75% by weight, such as 30% to 70% by weight, such as 30% to 65% by weight, such as 30% to 60% by weight, such as 35% to 99% by weight, such as 35% to 90% by weight, such as 35% to 85% by weight, such as 35% to 80% by weight, such as 35% to 75% by weight, such as 35% to 70% by weight, such as 35% to 65% by weight, such as 35% to 60% by weight, such as 40% to 99% by weight, such as 40% to 90% by weight, such as 40% to 85% by weight, such as 40% to 80% by weight, such as 40% to 75% by weight, such as 40% to 70% by weight, such as 40% to 65% by weight, such as 40% to 60% by weight, such as 45% to 99% by weight, such as 45% to 90% by weight, such as 45% to 85% by weight, such as 45% to 80% by weight, such as 45% to 75% by weight, such as 45% to 70% by weight, such as 45% to 65% by weight, such as 45% to 60% by weight, such as 50% to 99% by weight, such as 50% to 90% by weight, such as 50% to 85% by weight, such as 50% to 80% by weight, such as 50% to 75% by weight, such as 50% to 70% by weight, such as 50% to 65% by weight, such as 50% to 60% by weight, such as 55% to 99% by weight, such as 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 99% by weight, such as 60% to 90% by weight, such as 60% to 85% by weight, such as 60% to 80% by weight, such as 60% to 75% by weight, such as 60% to 70% by weight, such as 60% to 65% by weight, based on the total weight of polymerizable monomers used in the reaction mixture.

In addition or in lieu of constitutional units comprising the residue of an alkyl ester of (meth)acrylic acid, the dispersant copolymer may comprise constitutional units comprising the residue of an alpha, beta-ethylenically unsaturated carboxylic acid. Non-limiting examples of alpha, beta-ethylenically unsaturated carboxylic acids include those containing up to 18 carbon atoms such as acrylic acid and methacrylic acid, such as up to 16 carbon atoms, such as up to 12 carbon atoms, such as up to 10 carbon atoms. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. The constitutional units comprising the residue of the alpha, beta-ethylenically unsaturated carboxylic acids may comprise at least 0.1% by weight, such as at least 0.5% by weight, such as at least 1% by weight, such as at least 1.5% by weight, such as at least 3% by weight, such as at least 5% by weight, such as at least 7% by weight, such as at least 10% by weight, based on the total weight of the dispersant copolymer. The constitutional units comprising the residue of the alpha, beta-ethylenically unsaturated carboxylic acids may comprise no more than 30% by weight, such as no more than 20% by weight, such as no more than 15% by weight, such as no more than 10% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the dispersant copolymer. The constitutional units comprising the residue of the alpha, beta-ethylenically unsaturated carboxylic acids may comprise 0.1% to 30% by weight, such as 0.1% to 20% by weight, such as 0.1% to 15% by weight, such as 0.1% to 10% by weight, such as 0.1% to 8% by weight, such as 0.1% to 6% by weight, such as 0.1% by to 5% by weight, such as 0.1% to 4% by weight, such as 0.5% to 3% by weight, such as 0.1% to 2% by weight, such as 0.1% to 1.5% by weight, such as 0.1% to 1.0% by weight, such as 0.5% to 30% by weight, such as 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 30% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 30% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, such as 3% to 30% by weight, such as 3% to 20% by weight, such as 3% to 15% by weight, such as 3% to 10% by weight, such as 3% to 8% by weight, such as 3% to 6% by weight, such as 3% by to 5% by weight, such as 3% to 4% by weight, such as 5% to 30% by weight, such as 5% to 20% by weight, such as 5% to 15% by weight, such as 5% to 10% by weight, such as 5% to 8% by weight, such as 5% to 6% by weight, such as 7% to 30% by weight, such as 7% to 20% by weight, such as 7% to 15% by weight, such as 7% to 10% by weight, such as 7% to 8% by weight, such as 10% to 30% by weight, such as 10% to 20% by weight, such as 10% to 15% by weight, based on the total weight of the dispersant copolymer. The dispersant copolymer may be derived from a reaction mixture comprising the alpha, beta-ethylenically unsaturated carboxylic acids in an amount of 0.1% to 30% by weight, such as 0.1% to 20% by weight, such as 0.1% to 15% by weight, such as 0.1% to 10% by weight, such as 0.1% to 8% by weight, such as 0.1% to 6% by weight, such as 0.1% by to 5% by weight, such as 0.1% to 4% by weight, such as 0.5% to 3% by weight, such as 0.1% to 2% by weight, such as 0.1% to 1.5% by weight, such as 0.1% to 1.0% by weight, such as 0.5% to 30% by weight, such as 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 30% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 30% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, such as 3% to 30% by weight, such as 3% to 20% by weight, such as 3% to 15% by weight, such as 3% to 10% by weight, such as 3% to 8% by weight, such as 3% to 6% by weight, such as 3% by to 5% by weight, such as 3% to 4% by weight, such as 5% to 30% by weight, such as 5% to 20% by weight, such as 5% to 15% by weight, such as 5% to 10% by weight, such as 5% to 8% by weight, such as 5% to 6% by weight, such as 7% to 30% by weight, such as 7% to 20% by weight, such as 7% to 15% by weight, such as 7% to 10% by weight, such as 7% to 8% by weight, such as 10% to 30% by weight, such as 10% to 20% by weight, such as 10% to 15% by weight, based on the total weight of polymerizable monomers used in the reaction mixture. The inclusion of constitutional units comprising the residue of an alpha, beta-ethylenically unsaturated carboxylic acids in the dispersant copolymer results in a dispersant copolymer comprising at least one carboxylic acid group. Carboxylic acid groups resulting from inclusion of the alpha, beta-ethylenically unsaturated carboxylic acids may react with a separately added crosslinking agent that comprises functional groups reactive with carboxylic acid groups such as, for example, carbodiimides, polyepoxides, polyoxazolines, and polyaziridines.

The dispersant may optionally comprise constitutional units comprising the residue of an ethylenically unsaturated monomer comprising a hydroxyl functional group. Non-limiting examples of ethylenically unsaturated monomer comprising a hydroxyl functional group include hydroxyalkyl esters such as hydroxyethyl (meth)acrylate, hydroxypropyl (meth)acrylate, and hydroxybutyl (meth)acrylate. The constitutional units comprising the residue of an ethylenically unsaturated monomer comprising a hydroxyl functional group may comprise at least 0.1% by weight, such as at least 0.5% by weight, such as at least 1% by weight, such as at least 1.5% by weight, such as at least 3% by weight, such as at least 5% by weight, such as at least 7% by weight, such as at least 8% by weight, based on the total weight of the dispersant. The constitutional units comprising the residue of an ethylenically unsaturated monomer comprising a hydroxyl functional group may comprise no more than 25% by weight, such as no more than 20% by weight, such as no more than 15% by weight, such as no more than 10% by weight, such as no more than 8% by weight, such as no more than 6% by weight, such as no more than 5% by weight, such as no more than 3% by weight, such as no more than 2% by weight, such as no more than 1% by weight, based on the total weight of the dispersant. The constitutional units comprising the residue of an ethylenically unsaturated monomer comprising a hydroxyl functional group may comprise 0.1% to 25% by weight, such as 0.1% to 20% by weight, such as 0.1% to 15% by weight, such as 0.1% to 10% by weight, such as 0.1% to 8% by weight, such as 0.1% to 6% by weight, such as 0.1% by to 5% by weight, such as 0.1% to 3% by weight, such as 0.1% to 2% by weight, such as 0.1% to 1% by weight, 0.5% to 25% by weight, such as 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 3% by weight, such as 0.5% to 2% by weight, such as 0.5% to 1% by weight, such as 1% to 25% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 3% by weight, such as 1% to 2% by weight, such as 1.5% to 25% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 3% by weight, such as 1.5% to 2% by weight, such as 3% to 25% by weight, such as 3% to 20% by weight, such as 3% to 15% by weight, such as 3% to 10% by weight, such as 3% to 8% by weight, such as 3% to 6% by weight, such as 3% by to 5% by weight, such as 5% to 25% by weight, such as 5% to 20% by weight, such as 5% to 15% by weight, such as 5% to 10% by weight, such as 5% to 8% by weight, such as 5% to 6% by weight. such as 7% to 25% by weight, such as 7% to 20% by weight, such as 7% to 15% by weight, such as 7% to 10% by weight, such as 7% to 8% by weight, such as 8% to 25% by weight, such as 8% to 20% by weight, such as 8% to 15% by weight, such as 8% to 10% by weight, based on the total weight of the dispersant. The dispersant optionally may be derived from a reaction mixture comprising the ethylenically unsaturated monomer comprising a hydroxyl functional group in an amount of 0.1% to 25% by weight, such as 0.1% to 20% by weight, such as 0.1% to 15% by weight, such as 0.1% to 10% by weight, such as 0.1% to 8% by weight, such as 0.1% to 6% by weight, such as 0.1% by to 5% by weight, such as 0.1% to 3% by weight, such as 0.1% to 2% by weight, such as 0.1% to 1% by weight, 0.5% to 25% by weight, such as 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 3% by weight, such as 0.5% to 2% by weight, such as 0.5% to 1% by weight, such as 1% to 25% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 3% by weight, such as 1% to 2% by weight, such as 1.5% to 25% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 3% by weight, such as 1.5% to 2% by weight, such as 3% to 25% by weight, such as 3% to 20% by weight, such as 3% to 15% by weight, such as 3% to 10% by weight, such as 3% to 8% by weight, such as 3% to 6% by weight, such as 3% by to 5% by weight, such as 5% to 25% by weight, such as 5% to 20% by weight, such as 5% to 15% by weight, such as 5% to 10% by weight, such as 5% to 8% by weight, such as 5% to 6% by weight, such as 7% to 25% by weight, such as 7% to 20% by weight, such as 7% to 15% by weight, such as 7% to 10% by weight, such as 7% to 8% by weight, such as 8% to 25% by weight, such as 8% to 20% by weight, such as 8% to 15% by weight, such as 8% to 10% by weight, based on the total weight of polymerizable monomers used in the reaction mixture. The inclusion of constitutional units comprising the residue of an ethylenically unsaturated monomer comprising a hydroxyl functional group in the dispersant results in a dispersant comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides that have groups that are reactive with the hydroxyl groups are incorporated into the dispersant.

Alternatively, the dispersant may be substantially free, essentially free, or completely free of constitutional units comprising the residue of an ethylenically unsaturated monomer comprising a hydroxyl functional group.

The dispersant may be substantially free, essentially free, or completely free of constitutional units comprising the residue of an alkyl ester of (meth)acrylic acid comprising at least 8 carbon atoms in the alkyl group.

As used herein, the dispersant is “substantially free” of constitutional unis comprising the residue of a monomer if the monomer is present, if at all, in an amount of less than 0.1% by weight, based on the total weight of the dispersant. As used herein, the dispersant is “essentially free” of constitutional unis comprising the residue of a monomer if the monomer is present, if at all, in an amount of less than 0.01% by weight, based on the total weight of the dispersant. As used herein, the dispersant is “completely free” of constitutional units comprising the residue of a monomer if the monomer is not present in the dispersant, i.e., 0.000% by weight, based on the total weight of the dispersant.

The dispersant copolymer may further comprise constitutional units comprising the residue of a vinyl aromatic compound. Non-limiting examples of vinyl aromatic compounds includes styrene, alpha-methyl styrene, alpha-chlorostyrene, and vinyl toluene. The constitutional units comprising the residue of the vinyl aromatic compound may comprise at least 0.1% by weight, such as at least 1% by weight, such as at least 5% by weight, such as at least 10% by weight, such as at least 15% by weight, such as at least 20% by weight, such as at least 25% by weight, based on the total weight of the dispersant copolymer. The constitutional units comprising the residue of the vinyl aromatic compound may comprise no more than 50% by weight, such as no more than 40% by weight, such as no more than 30% by weight, such as no more than 20% by weight, such as no more than 15% by weight, such as no more than 10% by weight, based on the total weight of the dispersant copolymer. The constitutional units comprising the residue of the vinyl aromatic compound may comprise such as 0.1% to 50% by weight, such as 0.1% to 40% by weight, such as 0.1% to 30% by weight, such as 0.1% to 20% by weight, such as 0.1% to 15% by weight, such as 0.1% to 10% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 50% by weight, such as 10% to 40% by weight, such as 10% to 30% by weight, such as 10% to 20% by weight, such as 10% to 15% by weight, such as 15% to 50% by weight, such as 15% to 40% by weight, such as 15% to 30% by weight, such as 15% to 20% by weight, such as 20% to 50% by weight, such as 20% to 40% by weight, such as 20% to 30% by weight, such as 25% to 50% by weight, such as 25% to 40% by weight, such as 25% to 30% by weight, based on the total weight of the dispersant copolymer. The dispersant copolymer may be derived from a reaction mixture comprising the vinyl aromatic compound in an amount of such as 0.1% to 50% by weight, such as 0.1% to 40% by weight, such as 0.1% to 30% by weight, such as 0.1% to 20% by weight, such as 0.1% to 15% by weight, such as 0.1% to 10% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 50% by weight, such as 10% to 40% by weight, such as 10% to 30% by weight, such as 10% to 20% by weight, such as 10% to 15% by weight, such as 15% to 50% by weight, such as 15% to 40% by weight, such as 15% to 30% by weight, such as 15% to 20% by weight, such as 20% to 50% by weight, such as 20% to 40% by weight, such as 20% to 30% by weight, such as 25% to 50% by weight, such as 25% to 40% by weight, such as 25% to 30% by weight, based on the total weight of polymerizable monomers used in the reaction mixture.

The dispersant may optionally comprise constitutional units comprising the residue of other alpha, beta-ethylenically unsaturated monomers. Non-limiting examples of other alpha, beta-ethylenically unsaturated monomers include organic nitriles such as acrylonitrile and methacrylonitrile; allyl monomers such as allyl chloride and allyl cyanide; monomeric dienes such as 1,3-butadiene and 2-methyl-1,3-butadiene; acetoacetoxyalkyl (meth)acrylates such as acetoacetoxyethyl methacrylate (AAEM) (which may be self-crosslinking); difunctional unsaturated monomers such as ethyleneglycol dimethacrylate, hexanediol diacrylate; vinyl esters such as vinyl acetate; N-vinyl acyclic amides; (meth) acrylamides such as acrylamide, N-butoxymethylol acrylamide, N-methylol acrylamide, isopropyl acrylamide, and diacetone acrylamide. The constitutional units comprising the residue of the other alpha, beta-ethylenically unsaturated monomers may comprise at least at least 0.5% by weight, such as at least 1% by weight, such as at least 1.5% by weight, based on the total weight of the dispersant. The constitutional units comprising the residue of the other alpha, beta-ethylenically unsaturated monomers may comprise 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the dispersant. The constitutional units comprising the residue of the other alpha, beta-ethylenically unsaturated monomers may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the dispersant. The dispersant optionally may be derived from a reaction mixture comprising the other alpha, beta-ethylenically unsaturated monomers in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

Alternatively, the dispersant may be substantially free, essentially free, or completely free of constitutional units comprising the residue of any of the other alpha, beta-ethylenically unsaturated monomers described above.

The monomers and relative amounts may be selected such that the resulting dispersant may have a Tg of +100° C. or less. The resulting dispersant may have a Tg of, for example, at least at least −70° C., such as at least −60° C., such as at least −55° C., such as at least −50° C., such as at least −40° C., such as at least −30° C., such as at least −20° C., such as at least −15° C., such as at least −10° C., such as at least −5° C., such as at least 0° C. The resulting dispersant may have a Tg of, for example, such as no more than +50° C., such as no more than +40° C., such as no more than +25° C., such as no more than +15° C., such as no more than +10° C., such as no more than +5° C., such as no more than 0° C. The resulting dispersant may have a Tg of, for example, such as −70 to +100° C., such as −70 to +50° C., such as −70 to +40° C., such as −70 to +25° C., such as −70 to +20° C., such as −70 to +15° C., such as −70 to +10° C., such as −70 to +5° C., such as −70 to 0° C., such as −60 to +100° C., such as −60 to +50° C., such as −60 to +40° C., such as −60 to +25° C., such as −60 to +20° C., such as −60 to +15° C., such as −60 to +10° C., such as −60 to +5° C., such as −60 to 0° C., such as −55 to +100° C., such as −55 to +50° C., such as −55 to +40° C., such as −55 to +25° C., such as −55 to +20° C., such as −55 to +15° C., such as −55 to +10° C., such as −55 to +5° C., such as −55 to 0° C., such as −50 to +100° C., such as −50 to +50° C., such as −50 to +40° C., such as −50 to +25° C., such as −50 to +20° C., such as −50 to +15° C., such as 31 50 to +10° C., such as −50 to +5° C., such as −50 to 0° C., such as −40 to +100° C., such as −40 to +50° C., such as −40 to +40° C., such as −40 to +25° C., such as −40 to +20° C., such as −40 to +15° C., such as −40 to +10° C., such as −40 to +5° C., such as −40 to 0° C., such as −30 to +100° C., such as −30 to +50° C., such as −30 to +40° C., such as −30 to +25° C., such as −30 to +20° C., such as −30 to +15° C., such as −30 to +10° C., such as −30 to +5° C., such as −30 to 0° C., such as −20 to +100° C., such as −20 to +50° C., such as −20 to +40° C., such as −20 to +25° C., such as −20 to +20° C., such as −20 to +15° C., such as −20 to +10° C., such as −20 to +5° C., such as −20 to 0° C., such as −15 to +100° C., such as −15 to +50° C., such as −15 to +40° C., such as −15 to +25° C., such as −15 to +20° C., such as −15 to +15° C., such as −15 to +10° C., such as −15 to +5° C., such as −15 to 0° C., such as −10 to +100° C., such as −10 to +50° C., such as −10 to +40° C., such as −10 to +25° C., such as −10 to +20° C., such as −10 to +15° C., such as −10 to +10° C., such as −10 to +5° C., such as −10 to 0° C., such as −5 to +100° C., such as −5 to +50° C., such as −5 to +40° C., such as −5 to +25° C., such as −5 to +20° C., such as −5 to +15° C., such as −5 to +10° C., such as −5 to +5° C., such as −5 to 0° C., such as 0 to +100° C., such as 0 to +50° C., such as 0 to +40° C., such as 0 to +25° C., such as 0 to +20° C., such as 0 to +15° C. A Tg that is below 0° C. may be desirable to ensure acceptable battery performance at low temperature.

The dispersant may have a weight average molecular weight of at least 2,000 g/mol, such as at least 5,000 g/mol, such as at least 20,000 g/mol, such as at least 50,000 g/mol, such as at least 75,000 g/mol, such as at least 95,000 g/mol. The dispersant may have a weight average molecular weight of no more than 1,000,000 g/mol, such as no more than 500,000 g/mol, such as no more than 200,000 g/mol, such as no more than 150,000 g/mol, such as no more than 100,000 g/mol. The dispersant may have a weight average molecular weight of 2,000 to 1,000,000 g/mol, such as 2,000 to 500,000 g/mol, such as 2,000 to 200,000 g/mol, such as 2,000 to 150,000 g/mol, such as 2,000 to 100,000 g/mol, such as 5,000 to 1,000,000 g/mol, such as 5,000 to 500,000 g/mol, such as 5,000 to 200,000 g/mol, such as 5,000 to 150,000 g/mol, such as 5,000 to 100,000 g/mol, such as 20,000 to 1,000,000 g/mol, such as 20,000 to 500,000 g/mol, such as 20,000 to 200,000 g/mol, such as 20,000 to 150,000 g/mol, such as 20,000 to 100,000 g/mol, such as 50,000 to 1,000,000 g/mol, such as 50,000 to 500,000 g/mol, such as 50,000 to 200,000 g/mol, such as 50,000 to 150,000 g/mol, such as 50,000 to 100,000 g/mol, such as 75,000 to 1,000,000 g/mol, such as 75,000 to 500,000 g/mol, such as 75,000 to 200,000 g/mol, such as 75,000 to 150,000 g/mol, such as 75,000 to 100,000 g/mol, such as 95,000 to 1,000,000 g/mol, such as 95,000 to 500,000 g/mol, such as 95,000 to 200,000 g/mol, such as 95,000 to 150,000 g/mol, such as 95,000 to 100,000 g/mol.

The dispersants may be prepared by conventional free radical initiated solution polymerization techniques in which the polymerizable monomers are dissolved in an organic medium comprising a solvent or a mixture of solvents and polymerized in the presence of a free radical initiator until conversion is complete.

Examples of free radical initiators are those which are soluble in the organic medium such as azobisisobutyronitrile, azobis(alpha, gamma-methylvaleronitrile), tertiary-butyl perbenzoate, tertiary-butyl peracetate, benzoyl peroxide, ditertiary-butyl peroxide and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications.

To prepare the dispersant, the solvent may be first heated to reflux and then a mixture of polymerizable monomers and a mixture of free radical initiator in an organic medium may be separately added to the refluxing solvent over a period of time. The reaction mixture is then held at polymerizing temperatures so as to reduce the free monomer content, such as to below 1.0 percent and usually below 0.5 percent, based on the total weight of the mixture of polymerizable monomers.

Following polymerization in the organic medium and prior to dispersion in an aqueous medium, the carboxylic acid groups of the dispersant, if present, may be at least partially neutralized by contacting said dispersant with a neutralizing base. Examples of suitable neutralizing bases include, but are not limited to tertiary amines such as, for example, dimethylethanolamine (DMEA), trimethyl amine, methyl diethanol amine, ethyl methyl ethanol amine, dimethyl ethyl amine, dimethyl propyl amine, dimethyl 3-hydroxy-1-propyl amine, dimeythylbenzyl amine, dimethyl 2-hydroxy-1-propyl amine, diethyl methyl amine, dimethyl 1-hydroxy-2-propyl amine, tricthyl amine, tributyl amine, N-methyl morpholine; ammonia; hydrazine; metallic aluminium; metallic zinc; water-soluble oxides of the elements Li, Na, K, Mg, Ca, Fe(II) and Sn(II); water-soluble hydroxides of the elements Li, Na, K, Mg. Ca, Fe(II) and Sn(II); water-soluble carbonates of the elements Li, Na, K, Mg, Ca, Fe(II) and Sn(II);and combinations thereof. The neutralizing base may comprise a tertiary amine. The neutralizing base may comprise dimethylethanolamine (DMEA).

The solution polymerized dispersant may be substantially dissolved and/or dispersed in water before, during or after the addition of neutralizing base. The solution polymerized dispersant may be substantially dissolved and/or dispersed in water during the addition of neutralizing base. Therefore, the solution polymerized dispersant may be formed in a solvent and subsequently substantially dissolved and/or dispersed in water. The solution polymerized dispersant may be formed in a solvent and subsequently substantially dissolved in water. The solution polymerized dispersant has sufficient functionality such that it may be substantially dissolved in water.

The dispersant may also be prepared by conventional emulsion polymerization techniques. The dispersant can be prepared by conventional emulsion batch process or a continuous process. In one example of a batch process, the monomer composition is fed over a period of 1 hour to 4 hours into a heated reactor initially charged with water. The initiator can be fed in simultaneously, it can be part of the monomer composition, or it can be charged to the reactor before feeding in the monomer composition. The optimum temperature depends upon the specific initiator being used. The length of time may range from 2 hours to 6 hours, and the temperature of reaction may range from 25° C. to 90° C.

In another example, water and a small portion of the monomer composition may be charged to a reactor with a small amount of surfactant and free radical initiator to form a seed. A preemulsion of the remaining monomers, surfactant and water are fed along with the initiator over a prescribed period of time (e.g., 3 hours) at a reaction temperature of about 80° C. to 85° C. using a nitrogen blanket. After a one-hour hold, upon completion of the monomer feed, a post redox feed to reduce residual free monomer (including hydrogen peroxide/isoascorbic acid) is added to the reactor. The latex product is then neutralized to a pH of 7 to 8.

The emulsion polymerization reaction mixture may comprise a surfactant. The surfactant may be an anionic, cationic, or non-ionic type stabilizer. Suitable examples of anionic surfactants include, but are not limited to, alkyl sulphates such as, for example, sodium dodecyl sulphate or sodium polyoxy ethylene alkyl ether sulphate; aryl sulphonates such as, for example, sodium dodecylbenzene sulphonate; sulphosuccinates such as, for example, sodium diisobutyl sulpho succinate, sodium dioctyl sulpho succinate and sodium di cyclohexyl sulpho succinate; and combinations thereof. Suitable examples of nonionic emulsifiers include, but are not limited to, fatty alcohol ethoxylates such as, for example polyethylene glycol mono lauryl ether; fatty acid ethoxylates such as, for example, polyethylene glycol mono stearate or polyethylene glycol mono laurate; polyether block polymers such as, for example, polyethylene glycol/polypropylene glycol block polymers also known as pluronics, commercial products of this type include Tergitol (RTM) XJ, XH or XD commercially available from Dow Chemical; and combinations thereof. Suitable examples of cationic emulsifiers include, but are not limited to, amine salts such as, for example, cetyl trimethyl ammonium chloride or benzyl dodecyl dimethyl ammonium bromide, and combinations thereof. It will be appreciated by a person skilled in the art that mixtures of anionic and cationic emulsifiers may not be desirable. Reactive surfactants can also be used wherein the surfactant contain an unsaturated group, such as an allyl group, capable of co-polymerizing with the ethylenically unsaturated monomers. Suitable examples include, but are not limited to, Adeka Reasoap SR-10, Hitenol BC-1025, and Maxemul 6106.

In order to conduct the polymerization of the ethylenically unsaturated monomers, a free radical initiator is usually present. Both water soluble and oil soluble initiators can be used. Since the addition of certain initiators, such as redox initiators, can result in a strong exothermic reaction, it is generally desirable to add the initiator to the other ingredients immediately before the reaction is to be conducted. Examples of water-soluble initiators include ammonium peroxydisulfate, potassium peroxydisulfate and hydrogen peroxide. Examples of oil soluble initiators include t-butyl hydroperoxide, dilauryl peroxide, t-butyl perbenzoate and 2,2′-azobis(isobutyronitrile). Redox initiators such as ammonium peroxydisulfate/sodium metabisulfite or t-butylhydroperoxide/isoascorbic acid may be utilized herein.

Alternatively, the dispersant in an aqueous medium can be prepared by a high stress technique such as microfluidization by use of a MICROFLUIDIZER® emulsifier which is available from Microfluidics Corporation in Newton, Mass. The MICROFLUIDIZER® high pressure impingement emulsifier is disclosed in U.S. Pat. No. 4,533,254, which is hereby incorporated by reference. The device consists of a high pressure (up to 1.4×10⁵ kPa (20,000 psi)) pump and an interaction chamber in which emulsification takes place. The pump forces the mixture of reactants in aqueous medium into the chamber where it is split into at least two streams which pass at very high velocity through at least two slits and collide, resulting in the particulation of the mixture into small particles. Generally, the reaction mixture is passed through the emulsifier once at a pressure of between 3.5×10⁴ and 1×10⁵ kPa (5,000 and 15,000 psi). Multiple passes can result in smaller average particle size and a narrower range for the particle size distribution. When using the aforesaid MICROFLUIDIZER® emulsifier, stress is applied by liquid-liquid impingement as has been described. However, it should be understood that, if desired, other modes of applying stress to the pre-emulsification mixture can be utilized so long as sufficient stress is applied to achieve the requisite particle size distribution, that is, such that after polymerization less than 20% of the polymer microparticles have a mean diameter greater than 5 microns. For example, one alternative manner of applying stress would be the use of ultrasonic energy.

Once the polymerization is complete, the resultant product is a stable dispersion of dispersant in an aqueous medium. The aqueous medium, therefore, may be substantially free of water-soluble dispersant. The resultant dispersants are, of course, insoluble in the aqueous medium. As used herein, “substantially free” means that the aqueous medium contains no more than 30% by weight of dissolved dispersant, such as no more than 15% by weight, based on the total weight of the dispersant. By “stably dispersed” is meant that the polymer microparticles do not settle upon standing and essentially do not coagulate or flocculate during manufacturing or on standing.

The particle size of the dispersant in the aqueous medium may be uniformly small, i.e., after polymerization less than 20% by weight of the dispersant have a mean diameter which is greater than 5 microns, such as greater than 1 micron. Generally, the dispersant has a mean diameter from 0.01 microns to 10 microns. The mean diameter of the dispersant after polymerization may range from 0.05 microns to 0.5 microns. The particle size can be measured with a particle size analyzer such as the Coulter N4 instrument commercially available from Coulter. The instrument comes with detailed instructions for making the particle size measurement. However, briefly, a sample of the aqueous dispersion is diluted with water until the sample concentration falls within specified limits required by the instrument. The measurement time is 10 minutes.

The dispersant copolymer may be present in the binder in amounts of at least 0.1% by weight, such as at least 1% by weight, such as at least 3% by weight, such as at least 5% by weight, such as at least 7% by weight, such as at least 9% by weight, such as at least 10% by weight, based on the total weight of the binder solids. The dispersant may be present in the binder in amounts of 25% by weight, such as no more than 20% by weight, such as no more than 15% by weight, such as no more than 10% by weight, based on the total weight of the binder solids. The dispersant may be present in the binder in amounts of 0.1% to 25% by weight, such as 0.1% to 20% by weight, such as 0.1% to 15% by weight, such as 0.1% to 10% by weight, such as 1% to 25% by weight, such as 1% to 20% by weight, such as 1% to 15% by weight, such as 1% to 10% by weight, such as 3% to 20% by weight, such as 3% to 15% by weight, such as 3% to 10% by weight, such as 5% to 20% by weight, such as 5% to 15% by weight, such as 5% to 10% by weight, such as 7% to 20% by weight, such as 7% to 15% by weight, such as 7% to 10% by weight, such as 9% to 20% by weight, such as 9% to 15% by weight, such as 9% to 10% by weight, such as 10% to 20% by weight, such as 10% to 15% by weight, based on the total weight of the binder solids.

The dispersant may be present in the slurry composition in an amount of at least 0.01% by weight, such as at least 0.05% by weight, such as at least 0.1% by weight, such as at least 0.3% by weight, based on the total solids weight of the slurry composition. The dispersant may be present in an amount of no more than 3% by weight, such as no more than 2% by weight, such as no more than 1% by weight, such as no more than 0.5% by weight, based on the total solids weight of the slurry composition. The dispersant may be present in an amount of 0.01% to 3% by weight, such as 0.01% to 2% by weight, such as 0.01% to 1% by weight, such as 0.01% to 0.5% by weight, such as 0.05% to 3% by weight, such as 0.05% to 2% by weight, such as 0.05% to 1% by weight, such as 0.05% to 0.5% by weight, such as 0.1% to 3% by weight, such as 0.1% to 2% by weight, such as 0.1% to 1% by weight, such as 0.1% to 0.5% by weight, such as 0.3% to 3% by weight, such as 0.3% to 2% by weight, such as 0.3% to 1% by weight, such as 0.3% to 0.5% by weight, based on the total solids weight of the slurry composition.

The dispersant may be present in the slurry composition in an amount of at least 0.005% by weight, such as at least 0.02% by weight, such as at least 0.05% by weight, such as at least 0.15% by weight, based on the total weight of the slurry composition. The dispersant may be present in an amount of no more than 1.5% by weight, such as no more than 1% by weight, such as no more than 0.5% by weight, such as no more than 0.3% by weight, based on the total weight of the slurry composition. The dispersant may be present in an amount of 0.005% to 1.5% by weight, such as 0.005% to 1% by weight, such as 0.005% to 0.5% by weight, such as 0.005% to 0.3% by weight, such as 0.02% to 1.5% by weight, such as 0.02% to 1% by weight, such as 0.02% to 0.5% by weight, such as 0.02% to 0.3% by weight, such as 0.05% to 1.5% by weight, such as 0.05% to 1% by weight, such as 0.05% to 0.5% by weight, such as 0.05% to 0.3% by weight, such as 0.15% to 1.5% by weight, such as 0.15% to 1% by weight, such as 0.15% to 0.5% by weight, such as 0.15% to 0.3% by weight, based on the total weight of the slurry composition.

The slurry composition of the present disclosure further comprises an aqueous medium. As used herein, the term “aqueous medium” refers to a liquid medium comprising greater than 50% by weight water, based on the total weight of the aqueous medium. The aqueous medium may comprise water in an amount of at least 60% by weight, such as at least 70% by weight, such as at least 80% by weight, such as at least 90% by weight, based on the total weight of the aqueous medium. The aqueous medium may comprise water in an amount of 51% to 100% by weight, such as 60% to 100% by weight, such as 70% to 100% by weight, such as 80% to 100% by weight, such as 90% to 100% by weight, based on the total weight of the aqueous medium. The aqueous medium may be present in an amount of at least 30% by weight, such as at least 35% by weight, such as at least 40% by weight, such as at least 45% by weight, based on the total weight of the slurry composition. The aqueous medium may be present in an amount of no more than 60% by weight, such as no more than 55% by weight, such as no more than 50% by weight, based on the total weight of the slurry composition. The aqueous medium may be present in an amount of such as 30% to 60% by weight, such as 30% to 55% by weight, such as 30% to 50% by weight, such as 35% to 60% by weight, such as 35% to 55% by weight, such as 35% to 50% by weight, such as 40% to 60% by weight, such as 40% to 55% by weight, such as 40% to 50% by weight, such as 45% to 60% by weight, such as 45% to 55% by weight, such as 45% to 50% by weight, based on the total weight of the slurry composition.

In addition or in lieu of the dispersant described above, the slurry composition may comprise a poly(2-alkyl or aryl oxazoline) polymer. As used herein, a “a poly(2-alkyl or aryl oxazoline) polymer” refers to a polymer prepared by polymerizing 2-alkyl or aryl oxazoline monomers by a cationic ring open polymerization reaction resulting in an acyl-substituted linear polyethylenimine polymer, and also refers to copolymers comprising the residue of 2-alkyl or aryl oxazoline monomers. Non-limiting example of a 2-alkyl or aryl oxazoline monomer includes 2-methyl-2-oxazoline, 2-ethyl-2-oxazoline, 2-phenyl-2-oxazoline, 2-butyl-2-oxazoline, 2-isopropenyl-2-oxazoline, and 2-isopropyl-2-oxazoline, among others. For example, the poly(2-alkyl or aryl oxazoline) polymer may be prepared according to the following schematic wherein R is an alkyl or aryl group, such as a C₁ to C₁₀ alkyl group, such as a C₁ to C₆ alkyl group, such as a C₁ to C₄ alkyl group, such as a C₁ to C₂ alkyl group, or a phenyl group, and initiator X may be an alkyl tosylate (such as where X₁ is methyl and X₂ is a toluenesulfonate) or a triflate (where X₁ is an alkyl or aryl group and X₂ is a triflate anion) or an alkyl halide such as benzyl bromide. The initiator may also contain other functional groups so long as it does not react during the polymerization such as olefin, alkyne, ester, amide, urethane, and/or ether groups for example:

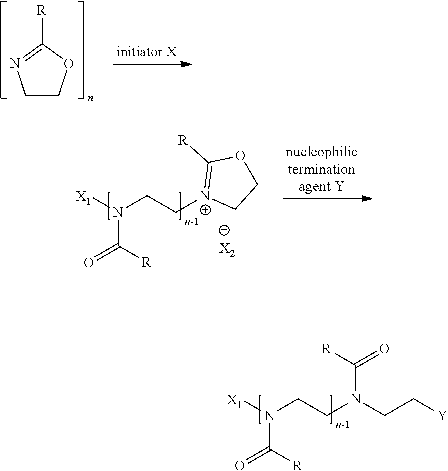

A nucleophilic termination agent Y can be used to stop the polymerization. Common examples include water, alcohols (aliphatic or aromatic), ammonia, amines (aliphatic or aromatic), thiols (aliphatic or aromatic), and/or carboxylic acids (aliphatic or aromatic) and corresponding carboxylate salts. The termination agent may also contain other functional groups such as ethylenically unsaturation, for example acrylic acid and methacrylic acid. The corresponding polyoxazolines containing functional initiator and/or termination group(s) can be incorporated into other polymer systems by covalent reaction. A non-limiting example of a poly(2-alkyl or aryl oxazoline) polymer is a poly(2-ethyl-2-oxazoline) polymer where R is an ethyl group in the schematic above. Other non-limiting examples of poly(2-alkyl or aryl oxazoline) polymers wherein R is a hydrocarbyl group comprising methyl, ethyl, propyl, butyl, propenyl, crotyl, or benzyl, or an acyl group comprising formyl, acetyl, propionyl, butyryl, acrylol, or crotonyl, or any combinations thereof. The polymerization reaction may be terminated by any suitable means, such as, for example, reaction with water, an alcohol, an acid, an amine, or a nucleophile.

The poly(2-alkyl or aryl oxazoline) polymer may be present in an amount of 0.1% to 25% by weight, such as 0.1% to 20% by weight, such as 0.1% to 15% by weight, such as 0.1% to 10% by weight, such as 1% to 25% by weight, such as 1% to 20% by weight, such as 1% to 15% by weight, such as 1% to 10% by weight, such as 3% to 20% by weight, such as 3% to 15% by weight, such as 3% to 10% by weight, such as 5% to 20% by weight, such as 5% to 15% by weight, such as 5% to 10% by weight, such as 7% to 20% by weight, such as 7% to 15% by weight, such as 7% to 10% by weight, such as 9% to 20% by weight, such as 9% to 15% by weight, such as 9% to 10% by weight, such as 10% to 20% by weight, such as 10% to 15% by weight, based on the total weight of the binder solids. The poly(2-alkyl or aryl oxazoline) polymer may be present in an amount of 0.005% to 1.5% by weight, such as 0.005% to 1% by weight, such as 0.005% to 0.5% by weight, such as 0.005% to 0.3% by weight, such as 0.02% to 1.5% by weight, such as 0.02% to 1% by weight, such as 0.02% to 0.5% by weight, such as 0.02% to 0.3% by weight, such as 0.05% to 1.5% by weight, such as 0.05% to 1% by weight, such as 0.05% to 0.5% by weight, such as 0.05% to 0.3% by weight, such as 0.15% to 1.5% by weight, such as 0.15% to 1% by weight, such as 0.15% to 0.5% by weight, such as 0.15% to 0.3% by weight, based on the total solids weight of the slurry composition. The poly(2-alkyl or aryl oxazoline) polymer may be present in an amount of 0.005% to 1.5% by weight, such as 0.005% to 1% by weight, such as 0.005% to 0.5% by weight, such as 0.005% to 0.3% by weight, such as 0.02% to 1.5% by weight, such as 0.02% to 1% by weight, such as 0.02% to 0.5% by weight, such as 0.02% to 0.3% by weight, such as 0.05% to 1.5% by weight, such as 0.05% to 1% by weight, such as 0.05% to 0.5% by weight, such as 0.05% to 0.3% by weight, such as 0.15% to 1.5% by weight, such as 0.15% to 1% by weight, such as 0.15% to 0.5% by weight, such as 0.15% to 0.3% by weight, based on the total weight of the slurry composition.

It has been surprisingly discovered that the use of the dispersant copolymer and/or the poly(2-alkyl or aryl oxazoline) polymer in a negative electrode waterborne slurry effectively breaks down agglomerates of carbonaceous materials in order to maintain a continuous carbon network to facilitate sufficient electrical contact.

The slurry composition may optionally further comprise a crosslinking agent. The crosslinking agent should be soluble or dispersible in the aqueous medium and be reactive with active hydrogen groups of the dispersant copolymer, such as the carboxylic acid groups and the hydroxyl groups, if present. Non-limiting examples of suitable crosslinking agents include aminoplast resins, phenoplast resins, carbodiimides, polyoxazolines, polyaziridines, blocked polyisocyanates, and polyepoxides.

Examples of aminoplast resins for use as a crosslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V. Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactone and methylethyl ketoxime. At curing temperatures, the blocking agents unblock exposing isocyanate functionality that is reactive with the hydroxyl functionality associated with the reactive polymers of the binder. Blocked polyisocyanate crosslinking agents are commercially available from Covestro as DESMODUR BL.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Carbodiimide crosslinking agents may be in monomeric or polymeric form, or a mixture thereof. Carbodiimide crosslinking agents refer to compounds having the following structure:

R—N═C═N—R′

wherein R and R′ may each individually comprise an aliphatic, aromatic, alkylaromatic, carboxylic, or heterocyclic group. Examples of commercially available carbodiimide crosslinking agents include, for example, those sold under the trade name CARBODILITE available from Nisshinbo Chemical Inc., such as CARBODILITE V-02-L2, CARBODILITE SV-02, CARBODILITE E-02, CARBODILITE SW-12G, CARBODILITE V-10 and CARBODILITE E-05.

Examples of polyoxazolines include compounds or polymers having two or more oxazoline groups in the molecule. Unlike the poly(2-alkyl or aryl oxazoline) polymer discussed above that is prepared by polymerizing 2-alkyl or aryl oxazoline monomers by a cationic ring open polymerization reaction resulting in an acyl-substituted linear polyethylenimine polymer, the polyoxazoline crosslinking agent includes at least two oxazoline groups in the molecule. Some or all of the hydrogen atoms of the oxazoline group may be substituted with other groups. Non-limiting examples of the divalent oxazoline compounds include 2,2′-bis(2-oxazoline), 2,2′-bis(4-methyl-2-oxazoline), 2,2′-bis(4,4-dimethyl-2-oxazoline), 2,2′-bis(4-ethyl-2-oxazoline), 2,2′-bis(4,4′-diethyl-2-oxazoline), 2,2′-bis(4-propyl-2-oxazoline), 2,2′-bis(4-butyl-2-oxazoline), 2,2′-bis(4-hexyl-2-oxazoline), 2,2′-bis(4-phenyl-2-oxazoline), 2,2′-bis(4-cyclohexyl-2-oxazoline), 2,2′-bis(4-benzyl-2-oxazoline). Non-limiting examples of polyoxazolines polymers include those comprising the residue of oxazoline group-containing monomer including 2-vinyl-2-oxazoline, 2-vinyl-4-methyl-2-oxazoline, 2-vinyl-4-ethyl-2-oxazoline, 2-vinyl-4-propyl-2-oxazoline, 2-vinyl-4-butyl-2-oxazoline, 2-vinyl-5-methyl-2-oxazoline, 2-vinyl-5-ethyl-2-oxazoline, 2-vinyl-5-propyl-2-oxazoline, 2-vinyl-5-butyl-2-oxazoline, 2-isopropenyl-2-oxazoline, 2-isopropenyl-4-methyl-2-oxazoline, 2-isopropenyl-4-ethyl-2-oxazoline, 2-isopropenyl-4-propyl-2-oxazoline, 2-isopropenyl-4-butyl-2-oxazoline, 2-isopropenyl-5-methyl-2-oxazoline, 2-isopropenyl-5-ethyl-2-oxazoline, 2-isopropenyl-5-propyl-2-oxazoline, and 2-isopropenyl-5-butyl-2-oxazoline. These oxazoline group-containing monomers may be used alone or in combination of two or more thereof at any ratio and may be polymerized with other ethylenically unsaturated monomers. Non-limiting examples of commercially available polyoxazoline curing agents include the EPOCROS line of crosslinkers available from NIPPON SHOKUBAI CO., LTD.

Examples of polyepoxide crosslinking agents are epoxy-containing (meth)acrylic polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

The crosslinking agent may be present in the slurry composition in amounts of at least 0.1% by weight, such as at least 0.3% by weight, such as at least 0.5% by weight, such as at least 1.0% by weight, such as at least 1.25% by weight, such as at least 1.5% by weight, such as at least 2.0% by weight, such as at least 2.5% by weight, based on the total weight of the binder solids. The crosslinking agent may be present in the slurry composition in amount of no more than 25% by weight, such as no more than 20% by weight, such as no more than 15% by weight, such as no more than 12.5% by weight, such as no more than 10% by weight, such as no more than 7.5% by weight, such as no more than 5% by weight, such as no more than 3% by weight, such as no more than 1.5% by weight, based on the total weigh of the binder solids. The crosslinking agent may be present in the slurry composition in amount of 0.1% to 25% by weight, such as 0.1% to 20% by weight, such as 0.1% to 15% by weight, such as 0.1% to 12.5% by weight, such as 0.1% to 10% by weight, such as 0.1% to 7.5% by weight, such as 0.1% to 5% by weight, such as 0.1% to 3% by weight, such as 0.1% to 1.5% by weight, such as 0.3% to 25% by weight, such as 0.3% to 20% by weight, such as 0.3% to 15% by weight, such as 0.3% to 12.5% by weight, such as 0.3% to 10% by weight, such as 0.3% to 7.5% by weight, such as 0.3% to 5% by weight, such as 0.3% to 3% by weight, such as 0.3% to 1.5% by weight, such as 0.5% to 25% by weight, such as 0.5% to 20% by weight, such as 0.5% to 15% by weight, such as 0.5% to 12.5% by weight, such as 0.5% to 10% by weight, such as 0.5% to 7.5% by weight, such as 0.5% to 5% by weight, such as 0.5% to 3% by weight, such as 0.5% to 1.5% by weight, such as 1.0% to 25% by weight, such as 1.0% to 20% by weight, such as 1.0% to 15% by weight, such as 1.0% to 12.5% by weight, such as 1.0% to 10% by weight, such as 1.0% to 7.5% by weight, such as 1.0% to 5% by weight, such as 1.0% to 3% by weight, such as 1.0% to 1.5% by weight, such as 1.25% to 25% by weight, such as 1.25% to 20% by weight, such as 1.25% to 15% by weight, such as 1.25% to 12.5% by weight, such as 1.25% to 10% by weight, such as 1.25% to 7.5% by weight, such as 1.25% to 5% by weight, such as 1.25% to 3% by weight, such as 1.25% to 1.5% by weight, such as 1.5% to 25% by weight, such as 1.5% to 20% by weight, such as 1.5% to 15% by weight, such as 1.5% to 12.5% by weight, such as 1.5% to 10% by weight, such as 1.5% to 7.5% by weight, such as 1.5% to 5% by weight, such as 1.5% to 3% by weight, such as 2.0% to 25% by weight, such as 2.0% to 20% by weight, such as 2.0% to 15% by weight, such as 2.0% to 12.5% by weight, such as 2.0% to 10% by weight, such as 2.0% to 7.5% by weight, such as 2.0% to 5% by weight, such as 2.0% to 3% by weight, such as 2.5% to 25% by weight, such as 2.5% to 20% by weight, such as 2.5% to 15% by weight, such as 2.5% to 12.5% by weight, such as 2.5% to 10% by weight, such as 2.5% to 7.5% by weight, such as 2.5% to 5% by weight, such as 2.5% to 3% by weight, based on the total weight of the binder solids.

As used herein, the term “binder solids” refers to the resinous components of the slurry composition and includes at least the binder resin (e.g., styrene butadiene copolymer). cellulose or cellulose derivative, the dispersant copolymer, the poly(2-alkyl or aryl oxazoline) polymer, and the crosslinking agent.

The binder solids may be present in the slurry composition in amounts of at least 1% by weight, such as at least 1.5% by weight, such as at least 2% by weight, such as at least 3% by weight, such as at least 4% by weight, based on the total solids weight of the slurry. The binder solids may be present in the slurry composition in amounts of no more than 10% by weight, such as no more than 7.5% by weight, such as no more than 5% by weight, such as no more than 4% by weight, such as no more than 3% by weight, based on the total solids weight of the slurry. The binder solids may be present in the slurry composition in amounts of 1% to 10% by weight, such as 1% to 7.5% by weight, such as 1% to 5% by weight, such as 1% to 4% by weight, such as 1% to 3% by weight, such as 1.5% to 10% by weight, such as 1.5% to 7.5% by weight, such as 1.5% to 5% by weight, such as 1.5% to 4% by weight, such as 1.5% to 3% by weight, such as 2% to 10% by weight, such as 2% to 7.5% by weight, such as 2% to 5% by weight, such as 2% to 4% by weight, such as 2% to 3% by weight, such as 3% to 10% by weight, such as 3% to 7.5% by weight, such as 3% to 5% by weight, such as 3% to 4% by weight, such as 4% to 10% by weight, such as 4% to 7.5% by weight, such as 4% to 5% by weight, based on the total solids weight of the slurry.

The slurry composition further comprises negative electrode active material. The material constituting the negative electrode active material contained in the slurry is not particularly limited and a suitable material can be selected according to the type of an electrical storage device of interest. The negative electrode active material may comprise graphite, silicon, silicon oxide, tin, germanium, silver, aluminum, barium, bismuth, copper, gallium, indium, nickel, phosphorous, lead, antimony, silicon, tin, strontium, zinc, titanium, or combinations thereof.

The negative electrode active material may be present in the slurry composition in an amount of at least 80% by weight, such as at least 85% by weight, such as at least 90% by weight, such as 91% by weight, such as at least 92% by weight, such as at least 93% by weight, such as at least 94% by weight, such as at least 95% by weight, such as at least 97% by weight, such as at least 98% by weight, such as 93% by weight, such as 94% by weight, such as 95% by weight, such as 97% by weight, such as 98% by weight, based on the total solids weight of the slurry composition. The negative electrode active material may be present in the slurry composition in an amount of no more than 98.9% by weight, such as no more than 97% by weight, such as no more than 95% by weight, based on the total solids weight of the slurry composition. The negative electrode active material may be present in the slurry composition in an amount of 80% to 98.9% by weight, such as 80% by 97% by weight, such as 80% to 95% by weight, such as 85% to 98.9% by weight, such as 85% by 97% by weight, such as 85% to 95% by weight, such as 90% to 98.9% by weight, such as 90% by 97% by weight, such as 90% to 95% by weight, such as 91% to 98.9% by weight, such as 91% to 97% by weight, such as 91% to 95% by weight, such as 92% to 98.9% by weight, such as 92% to 97% by weight, such as 92% to 95% by weight, such as 93% to 98.9% by weight, such as 93% to 97% by weight, such as 93% to 95% by weight, such as 94% to 98.9% by weight, such as 94% to 97% by weight, such as 94% to 95% by weight, such as 95% to 98.9% by weight, such as 95% to 97% by weight, such as 97% to 98.9% by weight, such as 98% to 98.9% by weight, based on the total solids weight of the slurry composition.

The negative electrode active material may be present in the slurry composition in an amount of at least 35% by weight, such as at least 40% by weight, such as at least 42% by weight, such as at least 44% by weight, such as at least 45% by weight, such as at least 47% by weight, such as at least 49% by weight, such as at least 51% by weight, based on the total weight of the slurry composition. The negative electrode active material may be present in the slurry composition in an amount of no more than 54% by weight, such as no more than 52% by weight, such as no more than 48.9% by weight, such as no more than 48% by weight, such as no more than 46% by weight, based on the total weight of the slurry composition. The negative electrode active material may be present in the slurry composition in an amount of 35% to 54% by weight, such as 35% to 52% by weight, such as 35% to 48.9% by weight, such as 35% to 48% by weight, such as 35% to 46% by weight, such as 40% to 54% by weight, such as 40% to 52% by weight. such as 40% to 48.9% by weight, such as 40% to 48% by weight, such as 40% to 46% by weight, such as 42% to 54% by weight, such as 42% to 52% by weight, such as 42% to 48.9% by weight, such as 42% to 48% by weight, such as 42% to 46% by weight, such as 45% to 54% by weight, such as 45% to 52% by weight, such as 45% to 48.9% by weight, such as 45% to 48% by weight, such as 45% to 46% by weight, such as 47% to 54% by weight, such as 47% to 52% by weight, such as 47% to 48.9% by weight, such as 47% to 48% by weight, such as 49% to 54% by weight, such as 49% to 52% by weight, based on the total weight of the slurry composition.

The slurry composition of the present disclosure may optionally further comprise an electrically conductive additive. The electrically conductive additive is a material that has a higher electrical conductivity than graphite. Non-limiting examples of electrically conductive additives include carbonaceous materials such as, activated carbon, carbon black such as acetylene black and furnace black, graphene, carbon nanotubes, including single-walled carbon nanotubes and/or multi-walled carbon nanotubes, carbon fibers, fullerene, and combinations thereof.

The electrically conductive additive may be present, if at all, in the slurry in amounts of at least 0.01% by weight, such as at least 0.05% by weight, such as at least 0.1% by weight, such as at least 0.5% by weight, such as at least 1% by weight, such as at least 1.5% by weight, such as at least 2% by weight, based on the total solids weight of the slurry. The electrically conductive additive may be present in the slurry in amounts of no more than 10% by weight, such as no more than 7.5% by weight, such as no more than 5% by weight, such as no more than 4% by weight, such as no more than 3% by weight, such as no more than 2.5% by weight, such as no more than 2% by weight, such as no more than 1.5% by weight, based on the total solids weight of the slurry. The electrically conductive additive may be present in the slurry in amounts of 0.01% to 10% by weight, such as 0.01% to 7.5% by weight, such as 0.01% to 5% by weight, such as 0.01% to 4% by weight, such as 0.01% to 3% by weight, such as 0.01% to 2.5% by weight, such as 0.01% to 2% by weight, such as 0.01% to 1.5% by weight, such as 0.05% to 10% by weight, such as 0.05% to 7.5% by weight, such as 0.05% to 5% by weight, such as 0.05% to 4% by weight, such as 0.05% to 3% by weight, such as 0.05% to 2.5% by weight, such as 0.05% to 2% by weight, such as 0.05% to 1.5% by weight, such as 0.1% to 10% by weight, such as 0.1% to 7.5% by weight, such as 0.1% to 5% by weight, such as 0.1% to 4% by weight, such as 0.1% to 3% by weight, such as 0.1% to 2.5% by weight, such as 0.1% to 2% by weight, such as 0.1% to 1.5% by weight, such as 0.5% to 10% by weight, such as 0.5% to 7.5% by weight, such as 0.5% to 5% by weight, such as 0.5% to 4% by weight, such as 0.5% to 3% by weight, such as 0.5% to 2.5% by weight, such as 0.5% to 2% by weight, such as 0.5% to 1.5% by weight, such as 1% to 10% by weight, such as 1% to 7.5% by weight, such as 1% to 5% by weight, such as 1% to 4% by weight, such as 1% to 3% by weight, such as 1% to 2.5% by weight, such as 1% to 2% by weight, such as 1% to 1.5% by weight, such as 1.5% to 10% by weight, such as 1.5% to 7.5% by weight, such as 1.5% to 5% by weight, such as 1.5% to 4% by weight, such as 1.5% to 3% by weight, such as 1.5% to 2.5% by weight, such as 1.5% to 2% by weight, such as 2% to 10% by weight, such as 2% to 7.5% by weight, such as 2% to 5% by weight, such as 2% to 4% by weight, such as 2% to 3% by weight, such as 2% to 2.5% by weight, based on the total solids weight of the slurry.

The negative electrode waterborne slurry composition may have a solids content of at least 30% by weight, such as at least 35% by weight, such as at least 40% by weight, such as at least 45% by weight, such as at least 50% by weight, such as at least 55% by weight, such as at least 60% by weight, based on the total weight of the slurry. The negative electrode waterborne slurry composition may have a solids content of no more than 70% by weight, such as no more than 60% by weight, such as no more than 55% by weight, such as no more than 50% by weight, such as no more than 45% by weight, such as no more than 40% by weight, such as no more than 35% by weight, based on the total weight of the slurry. The negative electrode waterborne slurry composition may have a solids content of 30% to 70% by weight, such as 30% to 60% by weight, such as 30% to 55% by weight, such as 30% to 50% by weight, such as 30% to 45% by weight, such as 30% to 40% by weight, such as 30% to 35% by weight, such as 35% to 70% by weight, such as 35% to 60% by weight, such as 35% to 55% by weight, such as 35% to 50% by weight, such as 35% to 45% by weight, such as 35% to 40% by weight, such as 40% to 70% by weight, such as 40% to 60% by weight, such as 40% to 55% by weight, such as 40% to 50% by weight, such as 40% to 45% by weight, such as 45% to 70% by weight, such as 45% to 60% by weight, such as 45% to 55% by weight, such as 45% to 50% by weight, such as 50% to 70% by weight, such as 50% to 60% by weight, such as 50% to 55% by weight, such as 55% to 70% by weight, such as 55% to 60% by weight, based on the total weight of the slurry.

As used herein, “solids content” or “total solids” refers to the non-volatile content of the slurry composition, i.e., materials which will not volatilize when heated to 150° C. for 60 minutes.

The negative electrode waterborne slurry composition may comprise a negative electrode active material, a binder comprising a styrene butadiene copolymer and a cellulose or cellulose derivative, the dispersant copolymer, and the aqueous medium, and may optionally further comprise a crosslinking agent and/or an electrically conductive additive.

The negative electrode waterborne slurry composition may comprise a negative electrode active material, a binder comprising a styrene butadiene copolymer and a cellulose or cellulose derivative, a melamine crosslinking agent, and an aqueous medium.

The negative electrode waterborne slurry composition comprising the aqueous medium, a negative electrode active material, binder (which may include a separately added crosslinking agent), dispersant copolymer, and optional ingredients, such as an electrically conductive additive, may be prepared by combining the ingredients to form the slurry. These substances can be mixed together by agitation with a known means such as a stirrer, bead mill or high-pressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing, and dispersion may ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The present disclosure is also directed to a negative electrode comprising (a) an electrical current collector; and (b) a film formed on the electrical current collector, wherein the film comprises a binder, a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant; and a negative electrode active material. The film may be deposited from the negative electrode waterborne slurry composition described above. The negative electrode may be manufactured by applying the above-described slurry composition to the surface of the current collector to form a coating film, and subsequently drying and/or curing the coating film. The coating film may have a thickness of at least 1 micron, such as 1 to 500 microns (μm), such as 10 to 100 microns, such as 10 to 70 microns, such as 10 to 50 microns, such as 10 to 30 microns, such as 20 to 100 microns, such as 20 to 70 microns, such as 20 to 50 microns, such as 20 to 30 microns, such as 25 to 100 microns, such as 25 to 70 microns, such as 25 to 50 microns, such as 25 to 30 microns, such as 35 to 100 microns, such as 35 to 70 microns, such as 35 to 50 microns. The coating film may comprise a cross-linked coating, and the film may further comprise the residue of a crosslinking agent. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

The binder may allow for production of negative electrodes that include graphite as the negative electrode active material having good charge density. For example, the electrodes may have an areal capacity of at least 0.5 mAh/cm², such as at least 1.0 mAh/cm², such as at least 2.0 mAh/cm², such as at least 2.5 mAh/cm², such as at least 3.0 mAh/cm², such as at least 3.5 mAh/cm², such as at least 4.0 mAh/cm², such as at least 4.5 mAh/cm², such as at least 5.0 mAh/cm², such as at least 6.0 mAh/cm², such as at least 7.0 mAh/cm², such as at least 8.0 mAh/cm², such as at least 10.0 mAh/cm². The electrode may have an areal capacity of no more than 10.0 mAh/cm², such as no more than 8.0 mAh/cm², such as no more than 7.0 mAh/cm², such as no more than 6.0 mAh/cm², such as no more than 5.0 mAh/cm², such as no more than 4.5 mAh/cm², such as no more than 4.0 mAh/cm², such as no more than 3.5 mAh/cm², such as no more than 3.0 mAh/cm², such as no more than 2.5 mAh/cm², such as no more than 2.0 mAh/cm², such as no more than 1.5 mAh/cm², such as no more than 1.0 mAh/cm². The electrode may have an areal capacity of 0.5 to 10.0 mAh/cm², such as 0.5 to 8.0 mAh/cm², such as 0.5 to 7.0 mAh/cm², such as 0.5 to 6.0 mAh/cm², such as 0.5 to 5.0 mAh/cm², such as 0.5 to 4.5 mAh/cm², such as 0.5 to 4.0 mAh/cm², such as 0.5 to 3.5 mAh/cm², such as 0.5 to 3.0 mAh/cm², such as 0.5 to 2.5 mAh/cm², such as 0.5 to 2.0 mAh/cm², such as 0.5 to 2.0 mAh/cm², such as 0.5 to 1.5 mAh/cm², such as 0.5 to 1.0 mAh/cm², such as 1.0 to 10.0 mAh/cm², such as 1.0 to 8.0 mAh/cm², such as 1.0 to 7.0 mAh/cm², such as 1.0 to 6.0 mAh/cm², such as 1.0 to 5.0 mAh/cm², such as 1.0 to 4.5 mAh/cm², such as 1.0 to 4.0 mAh/cm², such as 1.0 to 3.5 mAh/cm², such as 1.0 to 3.0 mAh/cm², such as 1.0 to 2.5 mAh/cm², such as 1.0 to 2.0 mAh/cm², such as 1.0 to 2.0 mAh/cm², such as 1.0 to 1.5 mAh/cm², such as 1.5 to 10.0 mAh/cm², such as 1.5 to 8.0 mAh/cm², such as 1.5 to 7.0 mAh/cm², such as 1.5 to 6.0 mAh/cm², such as 1.5 to 5.0 mAh/cm², such as 1.5 to 4.5 mAh/cm², such as 1.5 to 4.0 mAh/cm², such as 1.5 to 3.5 mAh/cm², such as 1.5 to 3.0 mAh/cm², such as 1.5 to 2.5 mAh/cm², such as 1.5 to 2.0 mAh/cm², such as 1.5 to 2.0 mAh/cm², such as 2.0 to 10.0 mAh/cm², such as 2.0 to 8.0 mAh/cm², such as 2.0 to 7.0 mAh/cm², such as 2.0 to 6.0 mAh/cm², such as 2.0 to 5.0 mAh/cm², such as 2.0 to 4.5 mAh/cm², such as 2.0 to 4.0 mAh/cm², such as 2.0 to 3.5 mAh/cm², such as 2.0 to 3.0 mAh/cm², such as 2.0 to 2.5 mAh/cm², such as 2.5 to 10.0 mAh/cm², such as 2.5 to 8.0 mAh/cm², such as 2.5 to 7.0 mAh/cm², such as 2.5 to 6.0 mAh/cm², such as 2.5 to 5.0 mAh/cm², such as 2.5 to 4.5 mAh/cm², such as 2.5 to 4.0 mAh/cm², such as 2.5 to 3.5 mAh/cm², such as 2.5 to 3.0 mAh/cm², such as 3.0 to 10.0 mAh/cm², such as 3.0 to 8.0 mAh/cm², such as 3.0 to 7.0 mAh/cm², such as 3.0 to 6.0 mAh/cm², such as 3.0 to 5.0 mAh/cm², such as 3.0 to 4.5 mAh/cm², such as 3.0 to 4.0 mAh/cm², such as 3.0 to 3.5 mAh/cm², such as 3.5 to 10.0 mAh/cm², such as 3.5 to 8.0 mAh/cm², such as 3.5 to 7.0 mAh/cm², such as 3.5 to 6.0 mAh/cm², such as 3.5 to 5.0 mAh/cm², such as 3.5 to 4.5 mAh/cm², such as 3.0 to 4.0 mAh/cm², such as 3.0 to 3.5 mAh/cm², such as 3.5 to 10.0 mAh/cm², such as 3.5 to 8.0 mAh/cm², such as 3.5 to 7.0 mAh/cm², such as 3.5 to 6.0 mAh/cm², such as 3.5 to 5.0 mAh/cm², such as 3.5 to 4.5 mAh/cm², such as 3.5 to 4.0 mAh/cm², such as 4.0 to 10.0 mAh/cm², such as 4.0 to 8.0 mAh/cm², such as 4.0 to 7.0 mAh/cm², such as 4.0 to 6.0 mAh/cm², such as 4.0 to 5.0 mAh/cm², such as 4.0 to 4.5 mAh/cm², such as 4.5 to 10.0 mAh/cm², such as 4.5 to 8.0 mAh/cm², such as 4.5 to 7.0 mAh/cm², such as 4.5 to 6.0 mAh/cm², such as 4.5 to 5.0 mAh/cm², such as 5.0 to 10.0 mAh/cm², such as 5.0 to 8.0 mAh/cm², such as 5.0 to 7.0 mAh/cm², such as 5.0 to 6.0 mAh/cm², such as 6.0 to 10.0 mAh/cm², such as 6.0 to 8.0 mAh/cm², such as 6.0 to 7.0 mAh/cm², such as 7.0 to 10.0 mAh/cm², such as 7.0 to 8.0 mAh/cm², such as 8.0 to 10.0 mAh/cm².

In addition, the current collector may be pretreated with a pretreatment composition prior to depositing the slurry composition. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The method of applying the slurry composition to the current collector is not particularly limited. The slurry composition may be applied by doctor blade coating, dip coating, reverse roll coating, direct roll coating, gravure coating, extrusion coating, immersion or brushing. Although the application quantity of the slurry composition is not particularly limited, the thickness of the coating formed after the aqueous medium is removed per side of the current collector may be at least 1 micron, such as 1 to 500 microns (μm), such as 150 to 500 μm, such as 200 to 500 μm, or thicker. For example, the thickness of the coating formed may be 200 microns or thicker per side.

Drying and/or crosslinking the coating film after application, if applicable, can be done, for example, by heating at elevated temperature, such as at least 40° C., such as at least 50° C., such as at least 60° C., such as 40-145° C., such as 50-120° C., such as 60-100° C. The time of heating will depend somewhat on the temperature. Generally, higher temperatures require less time for curing. Typically, curing times are for at least 30 seconds, such as at least 2 minutes, such as at least 5 minutes, and could range up to 60 minutes. The temperature and time should be sufficient such that the binder in the cured film is crosslinked (if applicable), that is, covalent bonds are formed between co-reactive groups on the polymers of the binder, such as carboxylic acid groups and hydroxyl groups and the N-methylol and/or the N-methylol ether groups of an aminoplast, isocyanato groups of a blocked polyisocyanate crosslinking agent. Other methods of drying the coating film include ambient temperature drying, microwave drying and infrared drying, and other methods of curing the coating film include e-beam curing and UV curing.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

The present disclosure is also directed to an electrical storage device. An electrical storage device according to the present disclosure can be manufactured by using the above negative electrode prepared from the negative electrode waterborne slurry composition of the present disclosure. The electrical storage device may further comprise a positive electrode, an electrolyte, and a polymer separator. The positive electrode comprises a positive electrode active material, non-limiting examples of which include active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiₓMn_{y}Co_{z})O₂ (also known as “NMC” wherein x+y+z is approximately 1, such as, for example, LiNi_{0.333}Mn_{0.333}Co_{0.333}O₂ abbreviated as NMC 111 or NMC 333, LiNi_{0.5}Mn_{0.3}Co_{0.2}O₂ abbreviated as NMC 532 (or NCM 523), LiNi_{0.6}Mn_{0.2}Co_{0.2}O₂ abbreviated as NMC 622 and LiNi_{0.8}Mn_{0.1}Co_{0.1}O₂ abbreviated as NMC 811), Li(NiCoAl)O₂, carbon-coated LiFePO₄, and combinations thereof. Non-limiting examples of materials capable of lithium conversion include sulfur, LiO₂, FeF₂ and FeF₃, Si, aluminum, tin, SnCo, Fe₃O₄, and combinations thereof. Electrical storage devices according to the present disclosure include a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include organic carbonate compounds such as propylene carbonate, ethylene carbonate, butylene carbonate, dimethyl carbonate, methyl ethyl carbonate and diethyl carbonate; lactone compounds such as y-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml). As used herein, the term “number average molecular weight” or “(Mₙ)” means the number average molecular weight (Mₙ) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

As used herein, the term “total solids” refers to the non-volatile components of the slurry composition of the present disclosure and specifically excludes the aqueous medium.

As used herein, the term “consists essentially of” includes the recited material or steps and those that do not materially affect the basic and novel characteristics of the claimed disclosure.

As used herein, the term “consists of” excludes any element, step or ingredient not recited.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” negative electrode active material, “a” dispersant copolymer, and “an” electrically conductive additive, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. Although various embodiments of the disclosure have been described in terms of “comprising”, embodiments consisting essentially of or consisting of are also within the scope of the present disclosure.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

Whereas specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof. Each of the characteristics and examples described herein, and combinations thereof, may be said to be encompassed by the present disclosure.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### EX-A

### Preparation of Dispersant Copolymers

Preparation of Comparative Dispersant A: To a four-neck round bottom flask equipped with a mechanical stir blade, thermocouple, and reflux condenser was added 114 grams of Dowanol PM. The solvent was heated to a set point of 125° C. under a nitrogen atmosphere. A monomer solution containing 228.8 grams of ethyl acrylate and 25.42 grams of acrylic acid was thoroughly mixed in a separate container. An initiator solution of 2.47 grams of tert-amyl peroctoate and 44.5 grams of Dowanol PM was prepared in a separate container. The initiator and monomer solutions were co-fed into the flask at the same time using addition funnels over 210 and 180 minutes, respectively. After the initiator and monomer feeds were complete, the monomer addition funnel was rinsed with 12.2 grams of Dowanol PM. The resulting dispersant mixture was held at 125° C. set point for 1 hour. A second initiator solution of 1.52 grams of tert-amyl peroctoate and 13.3 grams of Dowanol PM was prepared. Half of the second initiator solution was fed into the flask using addition funnel over 30 minutes. The dispersant mixture was held at 125° C. set point for 30 minutes. The remainder of the initiator solution was added over 30 minutes. Next the initiator addition funnel was rinsed with 6.08 grams of Dowanol PM. The dispersant mixture was then held at 125° C. set point for 30 minutes. After the 30-minute hold, the mixture was cooled to 70° C. After cooling to 70° C. 31.43 grams of dimethyl ethanolamine was added over 10 min. After the addition, the mixture was held at 70° C. for 10 min. Then 258 grams of warm (70° C.) deionized water was added over 60 minutes and subsequently mixed for 15 minutes. After mixing, the resin dispersion was poured into a suitable container. The total solids of the dispersant copolymer solution was measured to be 36.05% solids.

Preparation of Dispersant B: To a four-neck round bottom flask equipped with a mechanical stir blade, thermocouple, and reflux condenser was added 114 grams of Dowanol PM. The solvent was heated to a set point of 125° C. under a nitrogen atmosphere. A monomer solution containing 204.6 grams of ethyl acrylate, 24.2 grams of N-vinyl pyrrolidone, and 25.42 grams of acrylic acid was thoroughly mixed in a separate container. An initiator solution of 2.47 grams of tert-amyl peroctoate and 44.5 grams of Dowanol PM was prepared in a separate container. The initiator and monomer solutions were co-fed into the flask at the same time using addition funnels over 210 and 180 minutes, respectively. After the initiator and monomer feeds were complete, the monomer addition funnel was rinsed with 12.2 grams of Dowanol PM. The resulting dispersant mixture was held at 125° C. set point for 1 hour. A second initiator solution of 1.52 grams of tert-amyl peroctoate and 13.3 grams of Dowanol PM was prepared. Half of the second initiator solution was fed into the flask using addition funnel over 30 minutes. The dispersant mixture was held at 125° C. set point for 30 minutes. The remainder of the initiator solution was added over 30 minutes. Next the initiator addition funnel was rinsed with 6.08 grams of Dowanol PM. The dispersant mixture was then held at 125° C. set point for 30 minutes. After the 30-minute hold, the mixture was cooled to 70° C. After cooling to 70° C., 31.43 grams of dimethyl ethanolamine was added over 10 min. After the addition, the mixture was held at 70° C. for 10 min. Then 258 grams of warm (70° C.) deionized water was added over 60 minutes and subsequently mixed for 15 minutes. After mixing, the resin dispersion was poured into a suitable container. The total solids of the dispersant copolymer solution was measured to be 36.00% solids.

Preparation of Dispersant C: To a four-neck round bottom flask equipped with a mechanical stir blade, thermocouple, and reflux condenser was added 108 grams of Dowanol PM. The solvent was heated to a set point of 125° C. under a nitrogen atmosphere. A monomer solution containing 193.9 grams of butyl acrylate, 22.9 grams of N-vinyl pyrrolidone, and 24.1 grams of acrylic acid was thoroughly mixed in a separate container. An initiator solution of 2.34 grams of tert-amyl peroctoate and 42.1 grams of Dowanol PM was prepared in a separate container. The initiator and monomer solutions were co-fed into the flask at the same time using addition funnels over 210 and 180 minutes, respectively. After the initiator and monomer feeds were complete, the monomer addition funnel was rinsed with 11.5 grams of Dowanol PM. The resulting dispersant mixture was held at 125° C. set point for 1 hour. A second initiator solution of 1.44 grams of tert-amyl peroctoate and 12.6 grams of Dowanol PM was prepared. Half of the second initiator solution was fed into the flask using addition funnel over 30 minutes. The dispersant mixture was held at 125° C. set point for 30 minutes. The remainder of the initiator solution was added over 30 minutes. Next the initiator addition funnel was rinsed with 5.76 grams of Dowanol PM. The dispersant mixture was then held at 125° C. set point for 30 minutes. After the 30-minute hold, the mixture was cooled to 70° C. After cooling to 70° C., 29.8 grams of dimethyl ethanolamine was added over 10 min. After the addition, the mixture was held at 70° C. for 10 min. Then 244.4 grams of warm (70° C.) deionized water was added over 60 minutes and subsequently mixed for 15 minutes. After mixing, the resin dispersion was poured into a suitable container. The total solids of the dispersant copolymer solution was measured to be 35.60% solids.

Preparation of Dispersant D: To a four-neck round bottom flask equipped with a mechanical stir blade, thermocouple, and reflux condenser was added 108 grams of Dowanol PM. The solvent was heated to a set point of 125° C. under a nitrogen atmosphere. A monomer solution containing 193.9 grams of 2-ethylhexyl acrylate, 22.9 grams of N-vinyl pyrrolidone, and 24.1 grams of acrylic acid was thoroughly mixed in a separate container. An initiator solution of 2.34 grams of tert-amyl peroctoate and 42.1 grams of Dowanol PM was prepared in a separate container. The initiator and monomer solutions were co-fed into the flask at the same time using addition funnels over 210 and 180 minutes, respectively. After the initiator and monomer feeds were complete, the monomer addition funnel was rinsed with 11.5 grams of Dowanol PM. The resulting dispersant mixture was held at 125° C. set point for 1 hour. A second initiator solution of 1.44 grams of tert-amyl peroctoate and 12.6 grams of Dowanol PM was prepared. Half of the second initiator solution was fed into the flask using addition funnel over 30 minutes. The dispersant mixture was held at 125° C. set point for 30 minutes. The remainder of the initiator solution was added over 30 minutes. Next the initiator addition funnel was rinsed with 5.76 grams of Dowanol PM. The dispersant mixture was then held at 125° C. set point for 30 minutes. After the 30-minute hold, the mixture was cooled to 70° C. After cooling to 70° C., 29.8 grams of dimethyl ethanolamine was added over 10 min. After the addition, the mixture was held at 70° C. for 10 min. Then 244.4 grams of warm (70° C.) deionized water was added over 60 minutes and subsequently mixed for 15 minutes. After mixing, the resin dispersion was poured into a suitable container. The total solids of the dispersant copolymer solution was measured to be 35.4% solids.

Preparation of Dispersant E: To a four-neck round bottom flask equipped with a mechanical stir blade, thermocouple, and reflux condenser was added 114 grams of Dowanol PM. The solvent was heated to a set point of 125° C. under a nitrogen atmosphere. A monomer solution containing 204.6 grams of ethyl acrylate, 24.2 grams of N-vinyl pyrrolidone, and 25.42 grams of poly(ethyleneglycol) methyl ether methacrylate (Mn 500) was thoroughly mixed in a separate container. An initiator solution of 2.47 grams of tert-amyl peroctoate and 44.5 grams of Dowanol PM was prepared in a separate container. The initiator and monomer solutions were co-fed into the flask at the same time using addition funnels over 210 and 180 minutes, respectively. After the initiator and monomer feeds were complete, the monomer addition funnel was rinsed with 12.2 grams of Dowanol PM. The resulting dispersant mixture was held at 125° C. set point for 1 hour. A second initiator solution of 1.52 grams of tert-amyl peroctoate and 13.3 grams of Dowanol PM was prepared. Half of the second initiator solution was fed into the flask using addition funnel over 30 minutes. The dispersant mixture was held at 125° C. set point for 30 minutes. The remainder of the initiator solution was added over 30 minutes. Next the initiator addition funnel was rinsed with 6.08 grams of Dowanol PM. The dispersant mixture was then held at 125° C. set point for 30 minutes. After the 30-minute hold, the mixture was cooled to 70° C. The dispersant was poured into a suitable container. The total solids of the dispersant copolymer solution was measured to be 36.1% solids.

### Preparation of Carbon Dispersions

Comparative Example 1: CMC Control—No Dispersant Copolymer: To a plastic cup was added 14.8 g of carboxymethyl cellulose (“CMC”, Sigma Aldrich, DS=1.2, Mw=250,000, 2.66% solids), 8.0 g of deionized water and 0.5 g of carbon (TIMCAL C-NERGY™ SUPER C45). The mixture was hand mixed for 60 s prior to mixing in a centrifugal mixer at 2000 rpm for 30 s intervals for a total of 2 minutes, periodically inspecting the quality of carbon dispersion via drawdown.

Comparative Example 2: Dispersant A: To a plastic cup was added 13.36 g of CMC (Sigma Aldrich, DS=1.2, Mw=250,000, 2.66% solids), 7.5 g of deionized water, 0.22 g of Dispersant A (36.05% solids) and 0.53 g of carbon (TIMCAL C-NERGY™ SUPER C45). The mixture was hand mixed for 60 s prior to mixing in a centrifugal mixer at 2000 rpm for 30 s intervals for a total of 2 minutes, periodically inspecting the quality of carbon dispersion via drawdown.

Example 3: Dispersant B: To a plastic cup was added 13.36 g of CMC (Sigma Aldrich, DS=1.2, Mw=250,000, 2.66% solids), 9.5 g of deionized water, 0.22 g of Dispersant B (36% solids) and 0.53 g of carbon (TIMCAL C-NERGY™ SUPER C45). The mixture was hand mixed for 60 s prior to mixing in a centrifugal mixer at 2000 rpm for 30 s intervals for a total of 2 minutes, periodically inspecting the quality of carbon dispersion via drawdown.

Example 4: Dispersant C: To a plastic cup was added 13.36 g of CMC (Sigma Aldrich, DS=1.2, Mw=250,000, 2.66% solids), 11.0 g of deionized water, 0.22 g of Dispersant C (35.6% solids) and 0.53 g of carbon (TIMCAL C-NERGY™ SUPER C45). The mixture was hand mixed for 60 s prior to mixing in a centrifugal mixer at 2000 rpm for 30 s intervals for a total of 2 minutes, periodically inspecting the quality of carbon dispersion via drawdown.

Example 5: Dispersant D: To a plastic cup was added 13.36 g of CMC (Sigma Aldrich, DS=1.2, Mw=250,000, 2.66% solids), 12.0 g of deionized water, 0.22 g of Dispersant D (35.4% solids) and 0.53 g of carbon (TIMCAL C-NERGY™ SUPER C45). The mixture was hand mixed for 60 s prior to mixing in a centrifugal mixer at 2000 rpm for 30 s intervals for a total of 2 minutes, periodically inspecting the quality of carbon dispersion via drawdown.

Example 6: Dispersant E having 10% MPEG, 80.5% EA, and 9.5% NVP: To a plastic cup was added 13.36 g of CMC (Sigma Aldrich, DS=1.2, Mw=250,000, 2.66% solids), 13.0 g of deionized water, 0.22 g of Dispersant E (36.1% solids) and 0.53 g of carbon (TIMCAL C-NERGY™ SUPER C45). The mixture was hand mixed for 60 s prior to mixing in a centrifugal mixer at 2000 rpm for 30 s intervals for a total of 2 minutes, periodically inspecting the quality of carbon dispersion via drawdown.

Comparative Example 7: 0.3% PVP: To a plastic cup was added 13.36 g of CMC (Sigma Aldrich, DS=1.2, Mw=250,000, 2.66% solids), 14.0 g of deionized water, 0.08 g of PVP (Sigma Aldrich) and 0.53 g of carbon (TIMCAL C-NERGY™ SUPER C45). The mixture was hand mixed for 60 s prior to mixing in a centrifugal mixer at 2000 rpm for 30 s intervals for a total of 2 minutes, periodically inspecting the quality of carbon dispersion via drawdown.

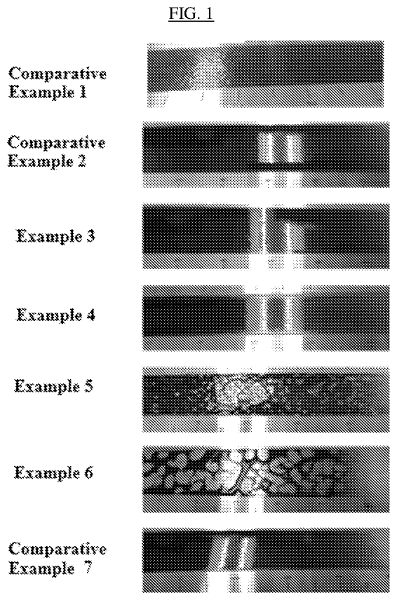

Evaluation of carbon dispersions: The final dispersions were applied via drawdown and visually evaluated. As shown in FIG. 1, Dispersants B and C provided a carbon dispersion that was at least comparable to Comparative Dispersant A and PVP, and superior to the control of comparative Example 1 that lacked a dispersant. The longer alkyl chain in Dispersant D from the use of EHA appears to have slightly degraded the dispersion quality. In addition, the lack of acrylic acid and the inclusion of MPEG in Dispersant E significantly dropped the dispersion quality.

### Preparation of Negative Electrode Waterborne Slurries

Comparative Example 1: CMC/SBR control: To a plastic cup was added 14.8 g of CMC (Sigma Aldrich, DS=1.2, Mw=250,000, 2.66% solids), 8.0 g of deionized water, and 0.5 g of carbon (TIMCAL C-NERGY™ SUPER C45). The mixture was mixed in a centrifugal mixer at 2000 rpm for 30 s intervals for a total of 5 minutes. 25 g of graphite (Superior 1506T) was then added and the mixture was mixed in a centrifugal mixer at 2000 rpm for 30 s intervals for a total of 5 minutes. Finally, 0.9 g of SBR (40% solids, Zeon BM-451B) was added and the mixture was manually stirred for 60 s prior to coating using a 4-mil drawdown bar to yield a 4.67 mg·cm⁻² coating weight on copper foil.

Comparative Example 2: Comparative Dispersant A: To a plastic cup was added 13.36 g of CMC (Sigma Aldrich, DS=1.2, Mw=250,000, 2.66% solids), 7.5 g of deionized water, 0.22 g of Comparative Dispersant A (36.05% solids) and 0.53 g of carbon (TIMCAL C-NERGY™ SUPER C45). The mixture was mixed in a centrifugal mixer at 2000 rpm for 30 s intervals for a total of 5 minutes. 25 g of graphite (Superior 1506T) was then added and the mixture was mixed in a centrifugal mixer at 2000 rpm for 30 s intervals for a total of 5 minutes. Finally, 0.9 g of styrene butadiene rubber (“SBR”, 40% solids, Zcon BM-451B) was added and the mixture was manually stirred for 60 s prior to coating using a 5-mil drawdown bar to yield a 4.71 mg·cm⁻² coating weight on copper foil.

Example 3: Dispersant B: To a plastic cup was added 13.36 g of CMC (Sigma Aldrich, DS=1.2. Mw=250,000, 2.66% solids), 9.5 g of deionized water, 0.22 g of dispersant B (36% solids) and 0.53 g of carbon (TIMCAL C-NERGY™ SUPER C45). The mixture was mixed in a centrifugal mixer at 2000 rpm for 30 s intervals for a total of 5 minutes. 25 g of graphite (Superior 1506T) was then added and the mixture was mixed in a centrifugal mixer at 2000 rpm for 30 s intervals for a total of 5 minutes. Finally, 0.9 g of SBR (40% solids, Zeon BM-451B) was added and the mixture was manually stirred for 60 s prior to coating using a 5-mil drawdown bar to yield a 4.71 mg·cm⁻² coating weight on copper foil.

Example 4: Dispersant C: To a plastic cup was added 13.36 g of CMC (Sigma Aldrich, DS=1.2, Mw=250,000, 2.66% solids), 11.0 g of deionized water, 0.22 g of Dispersant C (35.6% solids) and 0.53 g of carbon (TIMCAL C-NERGY™ SUPER C45). The mixture was mixed in a centrifugal mixer at 2000 rpm for 30 s intervals for a total of 5 minutes. 25 g of graphite (Superior 1506T) was then added and the mixture was mixed in a centrifugal mixer at 2000 rpm for 30 s intervals for a total of 5 minutes. Finally, 0.9 g of SBR (40% solids, Zeon BM-451B) was added and the mixture was manually stirred for 60 s prior to coating using a 5-mil drawdown bar to yield a 4.77 mg·cm⁻² coating weight on copper foil.

Example 5: Dispersant D: To a plastic cup was added 13.36 g of CMC (Sigma Aldrich, DS=1.2, Mw=250,000, 2.66% solids), 12.0 g of deionized water, 0.22 g of Dispersant D (35.4% solids) and 0.53 g of carbon (TIMCAL C-NERGY™ SUPER C45). The mixture was mixed in a centrifugal mixer at 2000 rpm for 30 s intervals for a total of 5 minutes. 25 g of graphite (Superior 1506T) was then added and the mixture was mixed in a centrifugal mixer at 2000 rpm for 30 s intervals for a total of 5 minutes. Finally, 0.9 g of SBR (40% solids, Zeon BM-451B) was added and the mixture was manually stirred for 60 s prior to coating using a 5-mil drawdown bar to yield a 4.71 mg·cm⁻² coating weight on copper foil.

Example 6: Dispersant E: To a plastic cup was added 13.36 g of CMC (Sigma Aldrich, DS=1.2, Mw=250,000, 2.66% solids), 13.0 g of deionized water, 0.22 g of Dispersant E (36.1% solids) and 0.53 g of carbon (TIMCAL C-NERGY™ SUPER C45). The mixture was mixed in a centrifugal mixer at 2000 rpm for 30 s intervals for a total of 5 minutes. 25 g of graphite (Superior 1506T) was then added and the mixture was mixed in a centrifugal mixer at 2000 rpm for 30 s intervals for a total of 5 minutes. Finally, 0.9 g of SBR (40% solids, Zeon BM-451B) was added and the mixture was manually stirred for 60 s prior to coating using a 5-mil drawdown bar to yield a 4.8 mg·cm⁻² coating weight on copper foil.

Comparative Example 7: 0.3% PVP: To a plastic cup was added 13.36 g of CMC (Sigma Aldrich, DS=1.2, Mw=250,000, 2.66% solids), 14.0 g of deionized water, 0.08 g of polyvinylpyrrolidone (“PVP”, Sigma Aldrich) and 0.53 g of carbon (TIMCAL C-NERGY™ SUPER C45). The mixture was mixed in a centrifugal mixer at 2000 rpm for 30 s intervals for a total of 5 minutes. 25 g of graphite (Superior 1506T) was then added and the mixture was mixed in a centrifugal mixer at 2000 rpm for 30 s intervals for a total of 5 minutes. Finally, 0.9 g of SBR (40% solids, Zeon BM-451B) was added and the mixture was manually stirred for 60 s prior to coating using a 5-mil drawdown bar to yield a 4.61 mg·cm⁻² coating weight on copper foil.

### Full Cell Coin-Cell Evaluation

Control 90/5/5 positive electrode control: A positive electrode having 90% by weight of LiNi_{0.5}Mn_{0.3}Co_{0.2}O₂ as the positive electrode active material, 5% by weight of SUPER P conductive carbon as an electrically conductive additive, and 5% by weight of a fluoropolymer-based binder was used as the electrode in the production of all coin cells described below.

Coin cells: Full coin cells were fabricated using the 90/5/5 cathode electrode control vs. the specific anode electrode. A ceramic coated 20 μm thick Celgard separator was used as the separator, soaked in 75 μL of an electrolyte solution comprised of 1.2 M LiPF₆ in EC:EMC at a 3:7 ratio with 2 wt. % VC. The coin cell was fabricated using 316 stainless steel casings, pairing a 1.0 cm diameter cathode electrode with a 1.2 cm diameter anode electrode. Evaluation of the cells was performed on a Bio-Logic BCS-805 tester using three formation cycles at 0.1 C followed by five cycles at each rate specified in Table 1 and Table 2.

TABLE 1
Table 1. Gravimetric discharge capacities (mAh ·
g⁻¹) for full coin cells formed with 3 × 0.1 C cycles
followed by a discharge rate capability study between 0.3-12 Ccycle.

| | | | | | | | Cap. at |
|---|---|---|---|---|---|---|---|
| | | Cap. at | Cap. at | Cap. at | Cap. at | Cap. at | second |
| Ex. No. | Dispersant | 0.3 C | 1 C | 3 C | 6 C | 12 C | 1 C |
| Comp. 1 | None | 155 | 147 | 138 | 126 | 66 | 137 |
| Comp. 2 | Dispersant A | 143 | 137 | 130 | 119 | 63 | 128 |
| 3 | Dispersant B | 150 | 142 | 135 | 126 | 83 | 135 |
| 4 | Dispersant C | 145 | 138 | 130 | 122 | 78 | 128 |
| 5 | Dispersant D | 140 | 136 | 133 | 124 | 73 | 130 |
| 6 | Dispersant E | 145 | 138 | 131 | 120 | 69 | 128 |
| Comp. 7 | PVP | 146 | 140 | 134 | 126 | 86 | 133 |

TABLE 2
Table 2. Discharge capacity retention (%) for full coin cells formed with 3 ×
0.1 C cycles followed by a discharge rate capability study between 0.3-12 Ccycle.

| | | Ret. at | Ret. at | Ret. at | Ret. at | Ret. at | Ret. at |
|---|---|---|---|---|---|---|---|
| Ex. No. | Dispersant | 0.3 C | 1 C | 3 C | 6 C | 12 C | 1 C |
| Comp. 1 | None | 100 | 95 | 88 | 81 | 43 | 88 |
| Comp. 2 | Dispersant A | 100 | 95 | 90 | 82 | 44 | 88 |
| 3 | Dispersant B | 100 | 94 | 89 | 83 | 55 | 89 |
| 4 | Dispersant C | 100 | 94 | 89 | 83 | 54 | 88 |
| 5 | Dispersant D | 100 | 97 | 94 | 88 | 52 | 92 |
| 6 | Dispersant E | 100 | 94 | 90 | 83 | 48 | 88 |
| Comp. 7 | PVP | 100 | 94 | 91 | 85 | 58 | 90 |

As shown in Table 1, each of Examples 3-6 provided comparable performance at each cycle relative to the control of Comparative Example 1 and Comparative Examples 2 and 7. Each of Examples 3-6 outperformed the control of Comparative Example 1 at 12 C.

As shown in Table 2, each of Examples 3-6 provided comparable performance at each cycle relative to the control of Comparative Example 1 and Comparative Examples 2 and 7. Each of Examples 3-6 outperformed the control of Comparative Example 1 at 3 C, 6 C, and 12 C.

### EX-B

### Preparation of Carbon Films

Example B1: CMC/SBR: To a plastic cup was added 15 of CMC (Nipon, DS=0.7, Mw=350,000, 2% solids), and 0.4 g of carbon (TIMCAL C-NERGY™ SUPER C45). The mixture was mixed in a centrifugal mixer with ZrO₂ milling beads (Glen mills, very high-density Zirconium Oxide, 5 mm) at 2000 rpm for 3 minutes. 4.85 g of deionized water was added and mixed in a centrifugal mixer for 30 seconds. Finally, 0.75 g of SBR (40% solids, Zeon BM-451B) was added and the mixture was mixed in a centrifugal mixer for 30 seconds prior to coating using a 10-mil drawdown bar onto a polytetrafluoroethylene film. This film was dried sequentially at 55° C. for 2 minutes and 100° C. for 4 minutes in an electric oven.

Example B2: CMC/SBR+0.1 wt. % Dispersant F: To a plastic cup was added 14.5 of CMC (Nipon, DS=0.7, Mw=350,000, 2% solids), and 0.4 g Dispersant F (available from Sigma Aldrich as poly(2-ethyl-2-oxazoline with MW=50,000, PDI=3-4, 5 wt. % solution in deionized water). The mixture was mixed in a centrifugal mixer at 2000 rpm for 30 seconds. 0.4 g of carbon (TIMCAL C-NERGY™ SUPER C45) and ZrO₂ milling beads (Glen mills, very high-density Zirconium Oxide, 5 mm) were added and mixed at 2000 rpm for 3 minutes. The carbon dispersion was diluted with 4.97 g of deionized water and mixed in a centrifugal mixer for 30 seconds. Finally, 0.72 g of SBR (40% solids, Zeon BM-451B) was added and the mixture was mixed in a centrifugal mixer for 30 seconds prior to coating using a 10 mil drawdown bar onto a polytetrafluoroethylene film. This film was dried sequentially at 55° C. for 2 minutes and 100° C. for 4 minutes in an electric oven.

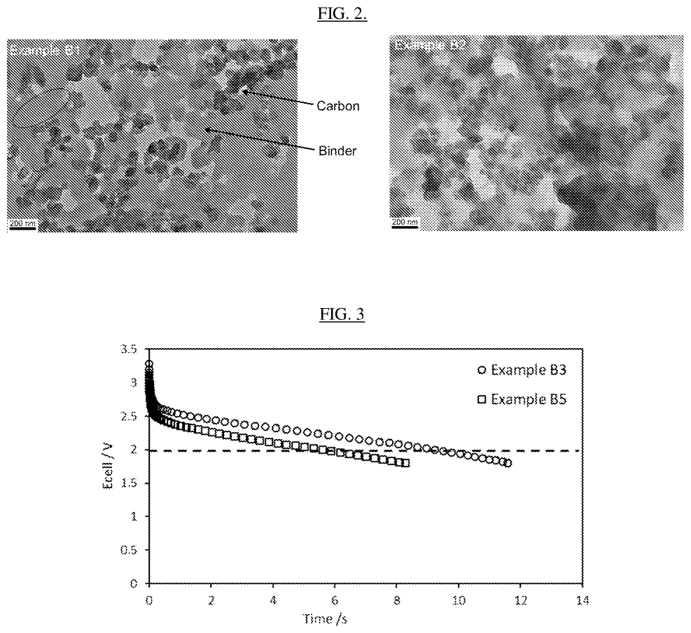

Transmission Electron Microscopy (TEM) Evaluation of Carbon Microstructure: A small amount of each film sample was embedded in EMBed-812 epoxy and cured at 60° C. for 24 hrs. Thin sections (<80 nm) were then ultra-microtomed and collected on Cu TEM grids. Images were acquired on the Tecnai T20 TEM operating at 200 kV. The TEM images in FIG. 2 of the carbon films show clear regions containing nano-sized carbon particles (black spheres) interspersed in a polymeric binder network (lighter, grey regions). In Example B1 there are regions in which the nano-sized carbon network encounters disruptions, as highlighted by the circle on the left portion of the figure. When this analysis is repeated using a carbon film prepared in example B2 there are noticeably fewer discontinuities in the carbon particle network. Once can easily trace a continuous carbon particle path from top to bottom in the Example 2 TEM image. A more continuous fractal carbon network is expected to engender a more conductive coating for example B2 compared to B1 with improved power performance.

### Multi-Layer Pouch Cell Rate Capability

Control 92/4.5/3.5 positive electrode: A positive electrode having 92% by weight of LiNi_{0.6}Mn_{0.2}Co_{0.2}O₂ as the positive electrode active material, 4.5% by weight of SUPER P conductive carbon as an electrically conductive additive, and 3.5% by weight of a fluoropolymer-based binder was used as the electrode in the production of all pouch cells described below.

Example B3 94/2/4 Control Anode: To a 10-L mixing pot was added 3.99 kg of CMC (Nipon, DS=0.7, Mw=350,000, 2% solids), and 106 g of carbon (TIMCAL C-NERGY™ SUPER C45). The mixture was mixed with a dual helical mixer at 40 rpm and a high-speed dispersion blade at 1600 rpm for one hour. 5 kg of graphite (Superior 1506-T) was added along with 605 g deionized water and mixed with a dual helical mixer at 40 rpm and a high speed dispersion blade at 1600 rpm for one hour. Then an additional 605 g of water was added and mixed with a dual helical mixer at 40 rpm and a high-speed dispersion blade at 1600 rpm for two hours. After overnight mixing with a dual helical mixer at 40 rpm, 332 g of SBR (40% solids, Zeon BM-451B) was added and the mixture was mixed with a dual helical mixer at 40 for 5 minutes. The slurry was filtered through a 150-um filter and coated onto copper foil using a reverse comma coater to at a 6.7 mg/cm² loading.

Example B4 94/2/4 Dispersant C Anode: To a 5-L mixing pot was added 1.80 kg of CMC (Nipon, DS=0.7, Mw=350,000, 2% solids) and 39.89 g Dispersant C (20% solids). This mixture was mixed with a dual helical mixer at 40 rpm for 5 minutes. 53.2 g of carbon (TIMCAL C-NERGY™ SUPER C45). The mixture was mixed with a dual helical mixer at 40 rpm and a high-speed dispersion blade at 1600 rpm for one hour. 2.5 kg of graphite (Superior 1506-T) was added along with 387 g deionized water and mixed with a dual helical mixer at 40 rpm and a high-speed dispersion blade at 1600 rpm for one hour. Then an additional 387 g of water was added and mixed with a dual helical mixer at 40 rpm and a high-speed dispersion blade at 1600 rpm for two hours. After overnight mixing with a dual helical mixer at 40 rpm, 156 g of SBR (40% solids, Zeon BM-451B) was added and the mixture was mixed with a dual helical mixer at 40 for 5 minutes. The slurry was filtered through a 150-um filter and coated onto copper foil using a reverse comma coater to at a 6.7 mg/cm² loading.

Example B5 94/2/4 Dispersant F Anode: To a 5-L mixing pot was added 1.93 kg of CMC (Nipon, DS=0.7, Mw=350,000, 2% solids) and 53.2 g of Dispersant F (poly(2-ethyl-2-oxazoline commercially available from Sigma-Aldrich, MW=50,000, PDI=3-4, 5 wt. % solution in deionized water). This mixture was mixed with a dual helical mixer at 40 rpm for 5 minutes. 53.2 g of carbon (TIMCAL C-NERGY™ SUPER C45). The mixture was mixed with a dual helical mixer at 40 rpm and a high-speed dispersion blade at 1600 rpm for one hour. 2.5 kg of graphite (Superior 1506-T) was added along with 160 g deionized water and mixed with a dual helical mixer at 40 rpm and a high-speed dispersion blade at 1600 rpm for one hour. Then an additional 160 g of water was added and mixed with a dual helical mixer at 40 rpm and a high-speed dispersion blade at 1600 rpm for two hours. After overnight mixing with a dual helical mixer at 40 rpm, 163 g of SBR (40% solids, Zeon BM-451B) was added and the mixture was mixed with a dual helical mixer at 40 for 5 minutes. The slurry was filtered through a 150-um filter and coated onto copper foil using a reverse comma coater to at a 6.7 mg/cm² loading.

Multi-layer pouch cells with a 1.1 Ah capacity were fabricated using the 92/4.5/3.5 cathode electrode control vs. the specific anode electrode. The cells were assembled with 4 cathodes and 5 anodes using a partially automated Z-folder stacker, with Entek 12 EPH as the separator, soaked in 4.4 g of an electrolyte solution comprised of 1 M LiPF₆ in EC:EMC at a 3:7 ratio with 2 wt. % VC. Evaluation of the cells was performed on a 10 A Maccor tester using four formation cycles at 0.1 C followed by five cycles at each rate specified in Table 3.

TABLE 3

| | | Cap. (Ah) | Cap. (Ah) | Cap. (Ah) | Cap. (Ah) | Cap. (Ah) |
|---|---|---|---|---|---|---|
| Ex. No. | Dispersant | at 0.3 C | at 1 C | at 3 C | at 6 C | at 9 C |
| B3 | None | 1.1 | 1.0 | 0.96 | 0.84 | 0.64 |
| B4 | Dispersant C | 1.1 | 1.0 | 0.94 | 0.85 | 0.70 |
| B5 | Dispersant F | 1.1 | 1.0 | 0.96 | 0.86 | 0.72 |

TABLE 4

| | | Ret. (%) | Ret. (%) | Ret. (%) | Ret. (%) | Ret. (%) |
|---|---|---|---|---|---|---|
| Ex. No. | Dispersant | at 0.3 C | at 1 C | at 3 C | at 6 C | at 9 C |
| B3 | None | 100 | 94 | 87 | 77 | 59 |
| B4 | Dispersant C | 100 | 95 | 88 | 79 | 65 |
| B5 | Dispersant F | 100 | 95 | 88 | 79 | 66 |

As shown in Table 3, each of examples B4 and B5 displayed a higher discharge capacity compared to control formulations when discharged at a rate of 9 C.

As shown in Table 4, examples B4 and B5 displayed a higher normalized discharge capacity retention compared to control formulations when discharged at a rate of 9 C.

### Low Temperature Performance Evaluation

Single-layer pouch cells with a capacity of 30 mAh were prepared in a fashion similar to those described above for the multi-layer pouch cells, however in this example only one layer of cathode and anode are used. These cells were filled with 0.6 g of 1 M LiPF₆ in 2:2:6 EC:PC:EMC (volume %) with 2 wt. % VC electrolyte. After 4 0.1 C formation cycles at room temperature, these cells were placed into an Espec BTZ-475 thermal chamber at −18° C. and let equilibrate at this temperature for 6 hours. Subsequently these cells were charged at 0.1 C and discharged at −12 C. As shown in FIG. 3, cells containing example B5 outperformed the control example B3, by taking several seconds longer to reach the experimental 2V cutoff voltage. Improved low temperature performance indicates lower internal resistance of the example B5 single layer pouch cells. Reduced internal resistance upon Dispersant F incorporation is correlated to the improved conductive carbon dispersion.

### EX-C

### Preparation of Negative Electrode Waterborne Slurries

Comparative Example C1—PVP: This slurry was prepared in a manner analogous to Comparative Example 1 in EX-A using 0.079 g PVP as the dispersing agent, 13.356 g CMC (Sigma Aldrich, DS=1.2, M_{w}=250,000, 2.66% solids), 9.0 g deionized water, 0.526 g of carbon (TIMCAL C-NERGY™ SUPER C45), 25.0 g of graphite (Superior 1506T), and 0.888 g of SBR (40% solids, Zeon BM-451B). The percent solids of the slurry was 53.9 wt. % based on total composition. The graphite anode film was cast using a 4-mil drawdown bar to yield a 4.5 mg·cm⁻² coating weight on copper foil.

Comparative Example C2—Dispersant G: This slurry was prepared in a manner analogous to Comparative Example 1 in EX-A using 0.039 g PVP. 0.039 g poly(2-ethyl-2-oxazoline) (commercially available from Sigma-Aldrich as a powder with MW=50,000, PDI=3-4), 13.356 g CMC (Sigma Aldrich, DS=1.2, M_{w}=250,000, 2.66% solids), 9.0 g deionized water, 0.526 g of carbon (TIMCAL C-NERGY™ SUPER C45), 25.0 g of graphite (Superior 1506T), and 0.888 g of SBR (40% solids, Zeon BM-451B). Dispersant G is comprised of PVP and poly(2-ethyl-2-oxazoline). The percent solids of the slurry was 53.9 wt. %. The graphite anode film was cast using a 5-mil drawdown bar to yield a 4.67 mg·cm⁻² coating weight on copper foil.

Example C3—Dispersant H: This slurry was prepared in a manner analogous to Comparative Example 1 in EX-A using 0.175 Dispersant C (22.55% solids based on total weight), 0.039 g poly(2-ethyl-2-oxazoline) (commercially available from Sigma-Aldrich as a powder with MW=50,000, PDI=3-4), 13.356 g CMC (Sigma Aldrich, DS=1.2, M_{w}=250,000, 2.66% solids), 9.0 g deionized water, 0.526 g of carbon (TIMCAL C-NERGY™ SUPER C45), 25.0 g of graphite (Superior 1506T), and 0.888 g of SBR (40% solids, Zeon BM-451B). Dispersant H is comprised of Dispersant C and poly(2-ethyl-2-oxazoline). The percent solids of the slurry was 53.7 wt. %. The graphite anode film was cast using a 5-mil drawdown bar to yield a 4.54 mg·cm⁻² coating weight on copper foil.

### Full Cell Coin-Cell Evaluation

Control 92/4/4 positive electrode control: A positive electrode having 92% by weight of LiNi_{0.5}Mn_{0.3}Co_{0.2}O₂ as the positive electrode active material, 4% by weight of SUPER P conductive carbon as an electrically conductive additive, and 4% by weight of a fluoropolymer-based binder was used as the electrode in the production of all coin cells described below.

Coin cells: Full coin cells were fabricated using the 92/4/4 cathode electrode control vs. the specific anode electrode. A ceramic coated 20 μm thick Celgard separator was used as the separator, soaked in 75 μL of an electrolyte solution comprised of 1.2 M LiPF₆ in EC:EMC at a 3:7 ratio with 2 wt. % VC. The coin cell was fabricated using 316 stainless steel casings, pairing a 1.0 cm diameter cathode electrode with a 1.2 cm diameter anode electrode. Evaluation of the cells was performed on a Bio-Logic BCS-805 tester using three formation cycles at 0.1 C followed by five cycles at each rate specified in Table 5 and Table 6.

TABLE 5

| | | Cap. (Ah) | Cap. (Ah) | Cap. (Ah) | Cap. (Ah) | Cap. (Ah) |
|---|---|---|---|---|---|---|
| Ex. No. | Dispersant | at 0.3 C | at 1 C | at 3 C | at 6 C | at 12 C |
| C1 | PVP | 159 | 149 | 138 | 123 | 51 |
| C2 | Dispersant G | 154 | 145 | 134 | 113 | 31 |
| C3 | Dispersant H | 151 | 144 | 134 | 119 | 62 |

TABLE 6

| | | Ret. (%) | Ret. (%) | Ret. (%) | Ret. (%) | Ret. (%) |
|---|---|---|---|---|---|---|
| Ex. No. | Dispersant | at 0.3 C | at 1 C | at 3 C | at 6 C | at 12 C |
| C1 | PVP | 98% | 92% | 86% | 77% | 32% |
| C2 | Dispersant G | 99% | 94% | 86% | 73% | 20% |
| C3 | Dispersant H | 100% | 96% | 88% | 79% | 41% |

As shown in Table 5 and Table 6, the use of dispersant H (C3) provided the equal or better absolute capacity and best capacity retention compared to PVP (C1) or a dispersant G (C2) at high C rates (6 C, and 12 C). Unexpectedly, the degradation in electrochemical performance was observed when high levels of nitrogen-containing heterocycle monomer were present in the dispersing agent (greater than 50%) in combination with poly(2-alkyl-2-oxazoline) or poly(2-aryl-2-oxazoline) dispersants.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A negative electrode waterborne slurry composition comprising:
a binder;
a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an alpha, beta-ethylenically unsaturated carboxylic acid-functional monomer, wherein the dispersant comprises 1% to 50% by weight of constitutional units comprising the residue of a monomer comprising a nitrogen-containing heterocycle and the % by weight is based on the total weight of the dispersant, and/or a poly(2-alkyl or aryl oxazoline) polymer;
a negative electrode active material; and
an aqueous medium.

2. The negative electrode waterborne slurry composition of claim 1, wherein the monomer comprising a nitrogen-containing heterocycle comprises vinyl pyrrolidone.

3. The negative electrode waterborne slurry composition of claim 1, wherein the dispersant comprises 1% to 99% by weight of constitutional units comprising the residue of the alkyl ester of a (meth)acrylic acid and/or the residue of the alpha, beta-ethylenically unsaturated carboxylic acid-functional monomer.

4. The negative electrode waterborne slurry composition of claim 1, wherein the dispersant further comprises an ethylenically unsaturated monomer comprising a hydroxyl functional group.

5. The negative electrode waterborne slurry composition of claim 1, wherein the dispersant has a glass transition temperature of −70 to +100° C.

6. The negative electrode waterborne slurry composition of claim 1, wherein the dispersant has weight average molecular weight of 2,000 to 1,000,000 g/mol.

7. The negative electrode waterborne slurry composition of claim 1, wherein the negative electrode waterborne slurry composition comprises the dispersant and the poly(2-alkyl or aryl oxazoline) polymer.

8. (canceled)

9. The negative electrode waterborne slurry composition of claim 1, wherein the binder comprises a styrene-butadiene copolymer.

10. The negative electrode waterborne slurry composition of claim 9, wherein the binder further comprises a cellulose or a cellulose derivative.

11. The negative electrode waterborne slurry composition of claim 1, wherein the negative electrode active material comprises graphite, silicon, silicon oxide, tin, germanium, silver, aluminum, barium, bismuth, copper, gallium, indium, nickel, phosphorous, lead, antimony, silicon, tin, strontium, zinc, titanium, or combinations thereof.

12. The negative electrode waterborne slurry composition of claim 1, further comprising a conductive additive comprising conductive carbon, carbon nanotubes, graphene, or any combination thereof.

13. The negative electrode waterborne slurry composition of claim 1, further comprising a crosslinking agent.

14. The negative electrode waterborne slurry composition of claim 1 comprising:
1% to 10% by weight of the binder;
optionally 0.1% to 1% by weight of the dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an alpha, beta-ethylenically unsaturated carboxylic acid-functional monomer, wherein the dispersant comprises 1% to 50% by weight of constitutional units comprising the residue of a monomer comprising a nitrogen-containing heterocycle and the % by weight is based on the total weight of the dispersant;
optionally 0.005% to 1.5% by weight of the poly(2-alkyl or aryl oxazoline) polymer, wherein at least one of the dispersant and the poly(2-alkyl or aryl oxazoline) polymer are present; and
90% to 98.9% by weight of the negative electrode active material, based on the total solids weight of the composition.

15. The negative electrode waterborne slurry composition of claim 1 comprising:
0.5% to 5% by weight of the binder;
optionally 0.01% to 0.5% by weight of the dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an alpha, beta-ethylenically unsaturated carboxylic acid-functional monomer, wherein the dispersant comprises 1% to 50% by weight of constitutional units comprising the residue of a monomer comprising a nitrogen-containing heterocycle and the % by weight is based on the total weight of the dispersant;
optionally 0.005% to 1.5% by weight of the poly(2-alkyl or aryl oxazoline) polymer, wherein at least one of the dispersant and the poly(2-alkyl or aryl oxazoline) polymer are present;
45% to 48.9% by weight of the negative electrode active material; and
45% to 50% by weight of the aqueous medium, based on the total weight of the composition.

16. The negative electrode waterborne slurry composition of claim 1 comprising:
75% to 99.9% by weight of the binder;
optionally 0.1% to 25% by weight of the dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an alpha, beta-ethylenically unsaturated carboxylic acid-functional monomer, wherein the dispersant comprises 1% to 50% by weight of constitutional units comprising the residue of a monomer comprising a nitrogen-containing heterocycle and the % by weight is based on the total weight of the dispersant, based on the total binder solids weight of the composition, and
optionally 0.1% to 25% by weight of the poly(2-alkyl or aryl oxazoline) polymer, wherein at least one of the dispersant and the poly(2-alkyl or aryl oxazoline) polymer are present.

17. A negative electrode comprising:
(a) an electrical current collector; and
(b) a film formed on the electrical current collector, wherein the film comprises:
a binder;
a negative electrode active material; and
at least one of:
a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant; or
a poly(2-alkyl or aryl oxazoline) polymer.

18. (canceled)

19. An electrical storage device comprising:
(a) the negative electrode of claim 17;
(b) a positive electrode; and
(c) an electrolyte.

20-21. (canceled)

22. The electrical storage device of claim 19, wherein the electrical storage device comprises a cell, a battery pack, a secondary battery, a capacitor, or a supercapacitor.

23. A negative electrode waterborne slurry composition comprising:
a negative electrode active material;
a binder comprising a cellulose or a cellulose derivative and a styrene-butadiene copolymer;
a melamine crosslinking agent; and
an aqueous medium.

24. The negative electrode waterborne slurry composition of claim 23, further comprising a dispersant comprising a copolymer comprising (a) constitutional units comprising the residue of a monomer comprising a nitrogen-containing heterocycle and (b) constitutional units comprising the residue of an alkyl ester of a (meth)acrylic acid and/or the residue of an acid-functional ethylenically unsaturated monomer, wherein the dispersant comprises 1% to 50% by weight of constitutional units comprising the residue of a monomer comprising a nitrogen-containing heterocycle and the % by weight is based on the total weight of the dispersant, and/or a poly(2-alkyl or aryl oxazolinc) polymer.

25. (canceled)
